(19) United States
(12) Patent Application Publication
(10) Pub. No.: US 2026/0042701 A1
(43) Pub. Date: Feb. 12, 2026

(54) GLASS, WINDOW GLASS FOR VEHICLES, GLASS FOR SENSORS, AND LAMINATED GLASS

(71) Applicant: AGC INC., Tokyo (JP)

(72) Inventors: Takato KAJIHARA, Tokyo (JP); Shigeki SAWAMURA, Tokyo (JP); Mikio NAGANO, Tokyo (JP)

(73) Assignee: AGC INC., Tokyo (JP)

(21) Appl. No.: 19/364,232

(22) Filed: Oct. 21, 2025

Related U.S. Application Data
(63) Continuation of application No. PCT/JP2024/014902, filed on Apr. 12, 2024.

(30) Foreign Application Priority Data
Apr. 28, 2023 (JP) 2023-075162

(51) Int. Cl. C03C 3/095; B32B 17/10

(52) U.S. Cl. CPC C03C 3/095; B32B 17/10036; B32B 17/10119; B32B 17/10137; B32B 2307/538; B32B 2307/718; B32B 2307/7376; B32B 2457/00; B32B 2605/08

(57) ABSTRACT

Provided is a glass having excellent fracture toughness and excellent bending moldability. This glass contains, in specific ranges as expressed in mol % based on oxides, components which are SiO₂, Al₂O₃, B₂O₃, MgO, CaO, SrO, BaO, Li₂O, Na₂O, K₂O, ZrO₂, TiO₂, Y₂O₃, R₂O, and RO (where RO is a total content of MgO, CaO, SrO, and BaO, and R₂O represents a total content of Li₂O, Na₂O, and K₂O).

### CROSS-REFERENCE TO RELATED APPLICATIONS

This is a continuation of International Application No. PCT/JP2024/014902 filed on Apr. 12, 2024, and claims priority under 35 USC 119 from Japanese Patent Application No. 2023-075162 filed on Apr. 28, 2023, the contents of which are incorporated herein by reference.

### TECHNICAL FIELD

The present invention relates to a glass, a vehicular window glass, a sensor-use glass, and a laminated glass.

### BACKGROUND ART

In recent years, a mobility-use glass such as a vehicular glass and a cover glass for sensors such as a light detection and ranging (LiDAR) is required to have a high strength in order to extend the life cycle from the viewpoint of carbon neutral.

In order to increase strength of the glass, for example, it is effective to increase Young's modulus and improve fracture toughness of the glass (see, for example, Patent Literature 1).
Patent Literature 1: JP2019-529298A
Patent Literature 2: JP2019-536728A

### SUMMARY OF INVENTION

However, a glass having a high Young's modulus and fracture toughness is likely to have a high viscosity. Therefore, such a glass is not suitable for applications requiring bending forming, such as a vehicular window glass and a cover glass for sensors such as a LiDAR.

For example, the glass described in Patent Literature 1 has a high Young's modulus of 85 GPa or more and a high fracture toughness value of 0.86 MPa·m^{1/2} or more, but has a high annealing point of 800° C. or higher. In addition, Patent Literature 2 discloses a glass having excellent bending formability which can be used even for a windshield, but the Young's modulus is as low as 70 GPa.

In view of the above problems, an object of the present invention is to provide a glass, a vehicular window glass, a sensor-use glass, and a laminated glass having excellent fracture toughness and excellent bending formability.

The inventors of the present invention have found that the above problems can be solved by using a glass having a specific composition range, and have completed the present invention.

That is, the present invention is as follows.
[1]A glass containing, in mol % in terms of oxides:
SiO₂: 60% to 72%;
Al₂O₃: 3.0% to 9.0%;
B₂O₃: 0.0% to 4.0%;
MgO: 3.0% to 15%;
CaO: 0.0% to 5.0%;
SrO: 0.0% to 5.0%;
BaO: 0.0% to 2.0%;
Li₂O: 1.0% to 10%;
Na₂O: 6.0% to 16%;
K₂O: 0.0% to 3.0%;
ZrO₂: 0.0% to 1.0%;
TiO₂: 0.0% to 1.0%;
Y₂O₃: 0.0% to 1.0%;
R₂O: 11% to 25%; and
RO: 7.0% to 20%,
   (RO is at least one selected from MgO, CaO, SrO, and BaO, and R₂O is at least one selected from Li₂O, Na₂O, and K₂O).
[2] The glass according to [1], which has a Young's modulus of 75 GPa or more.
[3] The glass according to [2], which has a fracture toughness value K_{IC} of 0.76 MPa·m^{1/2} or more, as measured by an SEPB method.
[4] The glass according to [1], which has a yield point of 670° C. or lower.
[5] The glass according to [4], which has a ratio (H/L) of 0.10 or less where an H value and an L value are calculated according to the following equations,

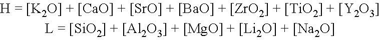

([ ] means a content of each component in the parentheses in mol % in terms of oxides).
[6] The glass according to [5], which has a fracture toughness value K_{IC} of 0.80 MPa·m^{1/2} or more, as measured by an SEPB method.
[7] The glass according to [1], which has a critical collision fracture rate of 35 km/h or more upon collision with a tungsten carbide superhard alloy having a tip curvature radius of 200 μm, an apex angle of 120°, and a weight of 1.365 g, when the glass has a surface roughness Ra of 5.0 nm or less and a thickness of 2.5 mm.
[8] The glass according to [1], which has a critical collision fracture rate of 53 km/h or more upon collision with a tungsten carbide superhard alloy having a tip curvature radius of 200 μm, an apex angle of 120°, and a weight of 1.365 g.
[9] The glass according to [8], which has a thickness of 2.5 mm or more.
[10]A vehicular window glass containing: the glass according to any one of [1] to [9].
[11]A sensor-use glass containing: the glass according to any one of [1] to [9].
[12]A laminated glass including:
a first glass plate;
a second glass plate; and
an interlayer sandwiched between the first glass plate and the second glass plate, in which
the first glass plate is the glass according to any one of [1] to [9].
[13] The laminated glass according to [12], which has a critical collision fracture rate of 35 km/h or more upon collision on a surface of the first glass plate with a tungsten carbide superhard alloy having a tip curvature radius of 200 μm, an apex angle of 120°, and a weight of 1.365 g, when the first glass plate has a surface roughness Ra of 5.0 nm or less and a thickness of 2.5 mm.
[14] The laminated glass according to [12] which has a critical collision fracture rate of 53 km/h or more upon collision on a surface of the first glass plate with a tungsten carbide superhard alloy having a tip curvature radius of 200 μm, an apex angle of 120°, and a weight of 1.365 g.
[15] The laminated glass according to [14], which has a total thickness of the first glass plate, the second glass plate, and the interlayer being 4.5 mm or more.
[16] The laminated glass according to [12], which has a ratio (t₁/t₂) of 1.5 or more where t₁ represents a thickness of the first glass plate and t₂ represents a thickness of the second glass plate.
[17]A laminated glass including:
a first glass plate;
a second glass plate; and
an interlayer sandwiched between the first glass plate and the second glass plate, in which
the first glass plate and the second glass plate are each the glass according to any one of [1] to [9].
[18] The laminated glass according to [12], in which the second glass plate is a soda lime glass.
[19] The laminated glass according to [12], in which the second glass plate is an aluminosilicate glass.
[20] The laminated glass according to [12], in which the second glass plate has been subjected to a chemical strengthening treatment.

According to the present invention, it is possible to provide a glass, a vehicular window glass, a sensor-use glass, and a laminated glass having excellent fracture toughness and excellent bending formability.

### BRIEF DESCRIPTION OF DRAWINGS

FIG. 1 is a diagram showing a relationship between H/L and a fracture toughness value.

FIG. 2 is a diagram showing a relationship between the H/L and a density.

FIG. 3 is a cross-sectional view of an example of a laminated glass according to one embodiment of the present invention.

FIG. 4 is a conceptual view illustrating a state where the laminated glass according to an embodiment of the present invention is used as a vehicular window glass.

FIG. 5 is an enlarged view of the portion S in FIG. 4.

FIG. 6 is a cross-sectional view taken along the line Y-Y in FIG. 5.

### DESCRIPTION OF EMBODIMENTS

Hereinafter, the present invention is described in details based on an embodiment, but the present invention is not limited to the present embodiment.

In the following drawings, members and portions having the same functions may be denoted by the same reference numerals, and duplicate descriptions may be omitted or simplified. The embodiments described in the drawings are schematic for the purpose of clearly illustrating the present invention, and do not necessarily accurately represent a size or a scale of an actual product.

In the present description, a numerical range indicated by using “to” indicates a range including numerical values described before and after “to” as a minimum value and a maximum value, respectively.

### <Glass Composition>

The present embodiment provides a glass containing, in mol % in terms of oxides:
SiO₂: 60% to 72%;
Al₂O₃: 3.0% to 9.0%;
B₂O₃: 0.0% to 4.0%;
MgO: 3.0% to 15%;
CaO: 0.0% to 5.0%;
SrO: 0.0% to 5.0%;
BaO: 0.0% to 2.0%;
Li₂O: 1.0% to 10%;
Na₂O: 6.0% to 16%;
K₂O: 0.0% to 3.0%;
ZrO₂: 0.0% to 1.0%;
TiO₂: 0.0% to 1.0%;
Y₂O₃: 0.0% to 1.0%;
R₂O: 11% to 25%; and
RO: 7.0% to 20%,
(RO is at least one selected from MgO, CaO, SrO, and BaO, and R₂O is at least one selected from Li₂O, Na₂O, and K₂O).

Hereinafter, a specific embodiment of the glass according to the present embodiment is described.

Note that, the composition range of each component is hereinafter be expressed in mol % in terms of oxides unless otherwise specified. In addition, “being substantially free of” a component means that the component is not contained except for inevitable impurities mixed from raw materials and the like, that is, the component is not intentionally contained.

SiO₂ is a component constituting a network structure of the glass, and is an essential component of the glass according to the present embodiment. In the glass according to the present embodiment, the content of SiO₂ is 60% to 72%. In the glass according to the present embodiment, in the case where the content of SiO₂ is 60% or more, the structure of the glass is strong, and Young's modulus and fracture toughness value can be increased. In addition, density of the glass can be easily reduced, and moisture resistance and chemical durability can be ensured. In addition, average linear expansion coefficient is prevented from increasing, and thermal cracking of the glass can be prevented. The content of SiO₂ is preferably 63% or more, more preferably 64% or more, still more preferably 65% or more, particularly preferably 66% or more, and most preferably 67% or more.

In addition, in the glass according to the present embodiment, in the case where the content of SiO₂ is 72% or less, an increase in viscosity during glass melting is prevented, production of the glass is easy, and formability for a vehicular glass, particularly a windshield, and a cover glass for sensors, is improved. The content of SiO₂ is preferably 71% or less, more preferably 70% or less, still more preferably 69% or less, and particularly preferably 68% or less.

Al₂O₃ is a component constituting the network structure of the glass, and is an essential component of the glass according to the present embodiment. The glass according to the present embodiment contains 3.0% to 9.0% of Al₂O₃. In the case where Al₂O₃ is 3.0% or more, Young's modulus can be increased. In addition, weather resistance, moisture resistance, and chemical durability are improved. In addition, average linear expansion coefficient is not excessively increased, thermal cracking of the glass can be prevented, and a chemical strengthening treatment using ion exchange is possible. The content of Al₂O₃ is preferably 3.2% or more, more preferably 3.4% or more, still more preferably 3.6% or more, particularly preferably 3.8% or more, and most preferably 4.0% or more.

In addition, in the glass according to the present embodiment, in the case where Al₂O₃ is 9.0% or less, an increase in viscosity during the glass melting is prevented, bending formability is improved, and formability for a vehicular glass, particularly a windshield, and a cover glass for sensors, is improved. The content of Al₂O₃ is preferably 7.0% or less, more preferably 6.5% or less, still more preferably 6.0% or less, particularly preferably 5.5% or less, and most preferably 5.0% or less.

B₂O₃ is a component constituting the network structure of the glass, and is a component that reduces the viscosity of the glass to improve meltability and bending formability. It also contributes to increasing the fracture toughness value. The glass according to the present embodiment contains 0.0% to 4.0% of B₂O₃. In general, a glass containing B₂O₃ and an alkali metal is difficult to produce since the alkali metal easily volatilizes during the production of the glass and erodes a furnace material of the furnace. In addition, in the case where the content of B₂O₃ is too large, in addition to the influence on the production facility described above, there is a concern that homogeneity of the glass decreases and optical quality deteriorates, and thus the glass is not suitable for sensor applications. Therefore, the content of B₂O₃ is preferably small, preferably 3.5% or less, more preferably 3.0% or less, still more preferably 2.5% or less, particularly preferably 2.0% or less, and most preferably substantially free of B₂O₃. Here, “substantially free of B₂O₃” means that the content of B₂O₃ in the glass is 0.050 mol % or less.

In the case where B₂O₃ is contained, the content of B₂O₃ may be 0.20% or more, 0.50% or more, 0.80% or more, 1.0% or more, or 1.2% or more.

MgO is a component that reduces the viscosity of the glass to improve meltability, and is a component that contributes to increasing Young's modulus and surface fracture energy to be described later. The glass according to the present embodiment contains 3.0% to 15% of MgO. In the case where the glass according to the present embodiment contains 3.0% or more of MgO, the viscosity of the glass can be reduced and melting of glass raw materials can be promoted. In addition, the Young's modulus can be increased. The content of MgO is preferably 4.0% or more, more preferably 5.0% or more, still more preferably 6.0% or more, particularly preferably 7.0% or more, and most preferably 8.0% or more.

In addition, in the glass according to the present embodiment, in the case where the content of MgO is 15% or less, the glass is less likely to undergo devitrification, the viscosity of the glass is prevented from excessively increasing, and formability for a vehicular glass, particularly a windshield, and a cover glass for sensors, is improved. The content of MgO is preferably 14% or less, more preferably 13% or less, still more preferably 12% or less, and particularly preferably 11% or less.

CaO is a component that reduces the viscosity of the glass and that improves bending formability. The glass according to the present embodiment contains 0.0% to 5.0% of CaO. In the case where CaO is contained in the glass according to the present embodiment, meltability of the glass raw materials is improved, and the viscosity is further reduced, so that formability for a vehicular glass, particularly a windshield, and a cover glass for sensors, is improved. In the glass according to the present embodiment, the content of CaO is preferably 0.20% or more, more preferably 0.40% or more, still more preferably 0.60% or more, particularly preferably 0.80% or more, and most preferably 1.0% or more.

In addition, in the glass according to the present embodiment, in the case where the content of CaO is 5.0% or less, an increase in density of the glass can be prevented, average linear expansion coefficient can be reduced, and thermal cracking of the glass can be prevented. The content of CaO in the glass plate according to the present embodiment is preferably 4.5% or less, more preferably 4.0% or less, particularly preferably 3.5% or less, and most preferably 3.0% or less.

SrO is a component that reduces viscosity of the glass and that improves bending formability. The glass according to the present embodiment contains 0.0% to 5.0% of SrO. In the case where SrO is contained in the glass according to the present embodiment, viscosity of the glass can be reduced. In the glass according to the present embodiment, the content of SrO is preferably 0.20% or more, more preferably 0.40% or more, still more preferably 0.60% or more, particularly preferably 0.80% or more, and most preferably 1.0% or more.

In addition, in the glass according to the present embodiment, in the case where the content of SrO is 5.0% or less, an increase in density of the glass can be prevented. In the glass according to the present embodiment, the content of SrO is preferably 4.5% or less, more preferably 4.0% or less, still more preferably 3.5% or less, even more preferably 3.0% or less, particularly preferably 2.5% or less, and most preferably 2.0% or less.

In the present embodiment, BaO is a component that reduces viscosity of the glass and that improves bending formability. The glass according to the present embodiment contains 0.0% to 2.0% of BaO. In the case where BaO is contained in the glass according to the present embodiment, viscosity of the glass is reduced. In the case where BaO is contained in the glass according to the present embodiment, the content of BaO is preferably 0.10% or more, more preferably 0.20% or more, still more preferably 0.30% or more, particularly preferably 0.40% or more, and most preferably 0.50% or more.

In addition, in the glass according to the present embodiment, in the case where the content of BaO is 2.0% or less, an increase in density of the glass can be prevented. In the glass according to the present embodiment, the content of BaO is preferably 1.8% or less, more preferably 1.6% or less, still more preferably 1.4% or less, particularly preferably 1.2% or less, and most preferably 1.0% or less.

Li₂O is a component that improves meltability of the glass and that reduces viscosity of the glass, and a component that makes it easier to increase Young's modulus and also contributes to the average linear expansion coefficient of the glass. Further, the strength of the glass can be increased by performing a chemical strengthening treatment by ion exchange with Na ions. In the glass according to the present embodiment, the content of Li₂O is 1.0% to 10%. In the case where the glass according to the present embodiment contains 1.0% or more of Li₂O, viscosity of the glass can be reduced. The content of Li₂O is preferably 1.5% or more, more preferably 2.0% or more, still more preferably 2.5% or more, particularly preferably 3.0% or more, and most preferably 3.5% or more.

In addition, in the case where the content of Li₂O is 10% or less, the glass is less likely to undergo devitrification, and the thermal cracking of the glass due to an excessively large average linear expansion coefficient can be prevented. In addition, since moisture resistance of the glass is improved, the glass is suitable as a glass to be exposed to the atmosphere for a long period of time, such as a vehicular window glass. The content of Li₂O is preferably 9.0% or less, more preferably 8.0% or less, still more preferably 7.0% or less, and particularly preferably 6.0% or less.

Na₂O is a component that improves meltability of the glass and that reduces viscosity of the glass, and a component that makes it easier to increase Young's modulus and also contributes to the average linear expansion coefficient of the glass. Further, the strength of the glass can be increased by performing a chemical strengthening treatment by ion exchange with K ions. In the glass according to the present embodiment, the content of Na₂O is 6.0% to 16%. In the case where the glass according to the present embodiment contains 6.0% or more of Na₂O, viscosity of the glass can be reduced. In addition, Young's modulus and average linear expansion coefficient can be increased. The content of Na₂O is preferably 7.0% or more, more preferably 8.0% or more, still more preferably 9.0% or more, and particularly preferably 10% or more.

In addition, in the case where the content of Na₂O is 16% or less, the thermal cracking of the glass due to an excessively large average linear expansion coefficient can be prevented. In addition, since moisture resistance of the glass is improved, the glass is suitable as a glass to be exposed to the atmosphere for a long period of time, such as a vehicular window glass. The content of Na₂O is preferably 15% or less, more preferably 14% or less, still more preferably 13% or less, and particularly preferably 12% or less.

K₂O is a component that improves meltability of the glass and that reduces viscosity of the glass, and a component that makes it easier to increase Young's modulus and also contributes to the average linear expansion coefficient of the glass. In the glass according to the present embodiment, the content of K₂O is 0.0% to 3.0%.

In the case where the glass according to the present embodiment contains K₂O, viscosity of the glass can be reduced. In addition, Young's modulus and average linear expansion coefficient can be increased. The content of K₂O is preferably 0.10% or more, more preferably 0.20% or more, still more preferably 0.30% or more, particularly preferably 0.40% or more, and most preferably 0.50% or more.

On the other hand, K₂O has an effect of increasing the average linear expansion coefficient and density as compared with Li₂O and Na₂O. In the case where the content of K₂O is 3.0% or less, the thermal cracking of the glass due to an excessively large average linear expansion coefficient can be prevented. The content of K₂O is preferably 2.5% or less, more preferably 2.0% or less, and still more preferably 1.5% or less.

ZrO₂ is a component that improves chemical durability and that increases Young's modulus. The glass according to the present embodiment contains 0.0% to 1.0% of ZrO₂. In the case where the glass according to the present embodiment contains ZrO₂, the content thereof is preferably 0.010% or more, more preferably 0.050% or more, still more preferably 0.10% or more, and particularly preferably 0.20% or more.

In addition, the content of ZrO₂ is preferably 0.80% or less, more preferably 0.70% or less, still more preferably 0.60% or less, and particularly preferably 0.50% or less, from the viewpoint of preventing an increase in density and viscosity of the glass.

TiO₂ is a component that improves chemical durability and that increases Young's modulus. The glass according to the present embodiment contains 0.0% to 1.0% of TiO₂. In the case where TiO₂ is contained in the glass according to the present embodiment, the content thereof is preferably 0.010% or more, more preferably 0.025% or more, still more preferably 0.050% or more, particularly preferably 0.10% or more, and most preferably 0.20% or more.

In addition, in the case where the content of TiO₂ is 1.0% or less, the thermal cracking of the glass due to an excessively large average linear expansion coefficient can be prevented. In addition, since TiO₂ has coloring in light in a visible region, a visible light transmittance may be reduced. The content of TiO₂ is preferably 0.90% or less, more preferably 0.80% or less, still more preferably 0.70% or less, and particularly preferably 0.60% or less.

Y₂O₃ is a component that increases Young's modulus. The glass according to the present embodiment contains 0.0% to 1.0% of Y₂O₃. In the case where the glass according to the present embodiment contains Y₂O₃, the content thereof is preferably 0.010% or more, more preferably 0.050% or more, still more preferably 0.10% or more, and particularly preferably 0.20% or more.

In the case where the content of Y₂O₃ is 1.0% or less, an increase in density and viscosity of the glass can be prevented. The content of Y₂O₃ is preferably 0.90% or less, more preferably 0.80% or less, still more preferably 0.70% or less, and particularly preferably 0.60% or less.

In the glass according to the present embodiment, the total content of Li₂O, Na₂O, and K₂O (hereinafter sometimes referred to as R₂O) is 11% to 25%. In the case where the R₂O is 11% or more, Young's modulus is increased and viscosity of the glass is reduced, so that formability for a vehicular glass, particularly a windshield, and a cover glass for sensors, is improved. The R₂O is preferably 12% or more, more preferably 13% or more, still more preferably 14% or more, and particularly preferably 15% or more.

In addition, in the case where the R₂O is 25% or less, an increase in density can be prevented and fracture toughness value can be increased. In addition, weather resistance and moisture resistance can also be improved. The R₂O is preferably 23% or less, more preferably 20% or less, still more preferably 19% or less, particularly preferably 18% or less, and most preferably 17% or less.

In the glass according to the present embodiment, a content ratio (Li₂O/R₂O) of Li₂O to R₂O is preferably 0.050 or more. In the case where the Li₂O/R₂O is 0.050 or more, the glass has a high Young's modulus, a high fracture toughness value, a low density, an excellent meltability, and an excellent bending formability. The Li₂O/R₂O is preferably 0.080 or more, more preferably 0.10 or more, still more preferably 0.12 or more, particularly preferably 0.15 or more, and most preferably 0.17 or more.

In addition, the Li₂O/R₂O is preferably 0.60 or less, more preferably 0.50 or less, still more preferably 0.45 or less, particularly preferably 0.42 or less, and most preferably 0.38 or less, from the viewpoint of preventing devitrification and lowering a devitrification temperature.

In addition, in the glass according to the present embodiment, a ratio of the total content of Na₂O and Li₂O to the R₂O ((Na₂O+Li₂O)/R₂O) is preferably 0.70 or more. In the case where the ((Na₂O+Li₂O)/R₂O) is 0.70 or more, the glass has a high Young's modulus, a high fracture toughness value, a low density, an excellent meltability, and an excellent bending formability. The ((Na₂O+Li₂O)/R₂O) is preferably 0.80 or more, more preferably 0.85 or more, still more preferably 0.90 or more, particularly preferably 0.92 or more, and most preferably 0.94 or more.

In the glass according to the present embodiment, the total content of MgO, CaO, SrO, and BaO (hereinafter sometimes referred to as RO) is 7.0% to 20%. In the case where the RO is 7.0% or more, Young's modulus can be increased, viscosity of the glass can be reduced, and meltability and bending formability of the glass can be improved. The RO is preferably 8.0% or more, more preferably 9.0% or more, and still more preferably 10% or more.

In addition, in the case where the RO is 20% or less, an increase in density of the glass can be prevented, and crack resistance of the glass can be improved. In addition, moisture resistance can be improved, and devitrification of the glass can be prevented. The RO is preferably 19% or less, more preferably 18% or less, still more preferably 17% or less, even more preferably 16% or less, particularly preferably 15% or less, and most preferably 14% or less.

In the glass according to the present embodiment, a content ratio of MgO to RO (MgO/RO) is preferably 0.20 or more. In the case where the MgO/RO is 0.20 or more, the glass has a high Young's modulus, a high fracture toughness value, a low density, an excellent meltability, and an excellent bending formability. The MgO/RO is preferably 0.25 or more, more preferably 0.33 or more, still more preferably 0.50 or more, particularly preferably 0.70 or more, and most preferably 0.75 or more.

In addition, the MgO/RO is preferably 1.0 or less, more preferably 0.98 or less, still more preferably 0.95 or less, particularly preferably 0.90 or less, and most preferably 0.85 or less, from the viewpoint of preventing devitrification caused by containing MgO and lowering the devitrification temperature.

In the glass according to the present embodiment, a ratio (H/L) of an H value to a L value calculated according to the following equations is preferably 0.10 or less.

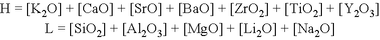

([ ] means a content of each component in the parentheses in mol % in terms of oxides.)

Here, the H value is the total of the contents of ZrO₂, TiO₂, and Y₂O₃, which are components that contribute to increasing Young's modulus and fracture toughness value but easily increase viscosity of the glass, and the contents of K₂O, CaO, SrO, and BaO, which are components that contribute to increasing density. The L value is the total of the contents of SiO₂ and Al₂O₃, which are network components, and the contents of MgO, Li₂O, and Na₂O, which are components that have a small increase in density and that contribute to increasing Young's modulus and fracture toughness value.

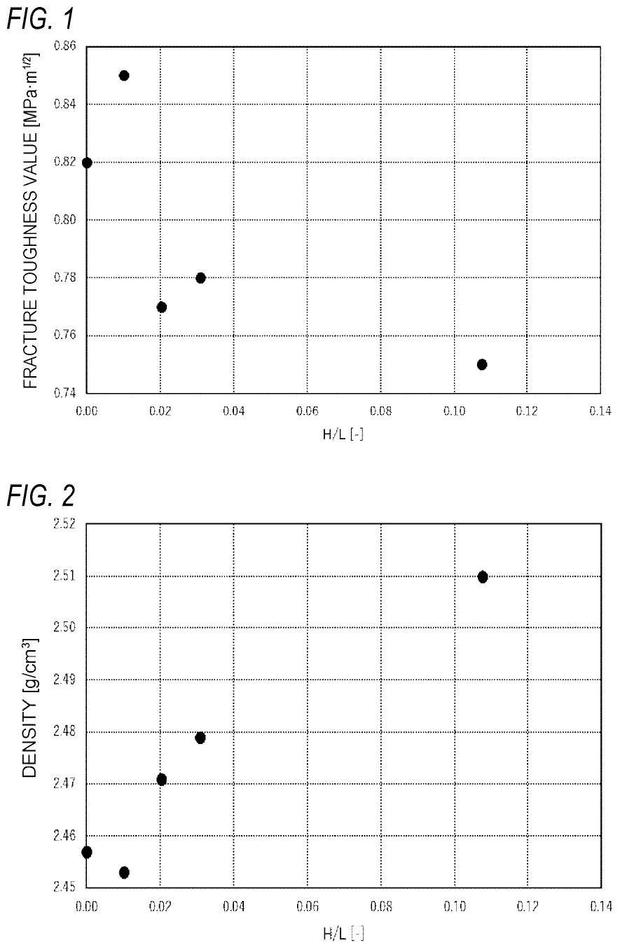

The inventors of the present invention have found that the ratio (H/L) of the H value to the L value correlates with the fracture toughness value and the density. Specifically, it has been found that the fracture toughness value is improved as the H/L is smaller as shown in FIG. 1, and the density is reduced as the H/L is smaller as shown in FIG. 2. In the present embodiment, in the case where the H/L is preferably 0.10 or less, the density can be reduced while increasing the fracture toughness value. The H/Lis more preferably 0.080 or less, still more preferably 0.070 or less, even more preferably 0.060 or less, particularly preferably 0.050 or less, and most preferably 0.040 or less.

### [Other Components]

Since Fe₂O₃ is a component that improves heat shielding property of the glass and is also a component that contributes to color tone of the glass, Fe₂O₃ may be contained in the glass according to the present embodiment. In the glass according to the present embodiment, the content of total iron in terms of Fe₂O₃ is preferably 0.0025% to 1.2%. Note that, the content of the total iron in terms of Fe₂O₃ here refers to the total amount of iron including FeO which is an oxide of divalent iron and Fe₂O₃ which is an oxide of trivalent iron.

In the case where Fe₂O₃ is contained, the glass is suitable for applications requiring heat shielding property. Further, in the case where Fe₂O₃ is contained, a load on a melting furnace due to heat radiation reaching a bottom surface of the melting furnace during the glass melting can be prevented.

In the case where the glass according to the present embodiment is used as a vehicular glass, the content of the total iron in terms of Fe₂O₃ in the glass according to the present embodiment is preferably 0.0025% or more, more preferably 0.0040% or more, still more preferably 0.039% or more, even more preferably 0.097% or more, even still more preferably 0.11% or more, particularly preferably 0.15% or more, and most preferably 0.17% or more, from the viewpoint of improving heat shielding property, imparting designability, and facilitating heat transfer to the glass during bending forming of the glass.

In addition, the content of the total iron in terms of Fe₂O₃ is preferably 1.0% or less, more preferably 0.80% or less, still more preferably 0.60% or less, particularly preferably 0.50% or less, and most preferably 0.40% or less, from the viewpoint of preventing a decrease in light transmittance in a visible region.

In the case where the glass according to the present embodiment is used as a cover glass for a LiDAR or a camera, the content of the total iron in terms of Fe₂O₃ is preferably 0.0030% or more, more preferably 0.0032% or more, still more preferably 0.0034% or more, even more preferably 0.0036% or more, even still more preferably 0.0038% or more, particularly preferably 0.0040% or more, and most preferably 0.0042% or more, from the viewpoint of facilitating melting of the raw materials during the production of the glass and from the viewpoint of reducing the amount of an expensive high purity raw material to be used.

In addition, the content of the total iron in terms of Fe₂O₃ is preferably 0.020% or less, more preferably 0.010% or less, still more preferably 0.0080% or less, particularly preferably 0.0070% or less, and most preferably 0.0060% or less, from the viewpoint of preventing a decrease in light transmittance in a visible region or a near-infrared region.

In the glass according to the present embodiment, a mass ratio (%) of divalent iron in terms of Fe₂O₃ in the total iron in terms of Fe₂O₃ (hereinafter referred to as Fe-Redox) is preferably 15% or more. The Fe-Redox value is a ratio of the content of Fe²⁺ in terms of Fe₂O₃ to the content of the total iron in terms of Fe₂O₃.

In the glass according to the present embodiment, in the case where the Fe-Redox is 15% or more, the content of Fe²⁺ having absorption in the near-infrared region can be increased, and thus heat is easily transferred to a melt of the glass during the production of the glass, and productivity is improved. In addition, since transmittance in the near-infrared region is reduced and heat shielding property can be improved, the glass is suitable for applications requiring heat shielding property, such as a vehicular glass.

In the case where the glass according to the present embodiment is used as a vehicular glass, the Fe-Redox is more preferably 20% or more, still more preferably 22% or more, and particularly preferably 24% or more. In addition, the Fe-Redox is preferably 50% or less. In the case where the Fe-Redox is 50% or less, deterioration of a melting facility can be prevented, and in addition, in the case where SO₃ is used as a fining agent, amber coloring can be prevented and a decrease in visible light transmittance can be prevented. The Fe-Redox is more preferably 45% or less, still more preferably 40% or less, and particularly preferably 38% or less.

On the other hand, in the case where the glass according to the present embodiment is used as a cover glass for a LiDAR, the Fe-Redox is more preferably 16% or more, still more preferably 17% or more, and particularly preferably 18% or more. In addition, the Fe-Redox is preferably 35% or less. In the case where the Fe-Redox is 35% or less, a decrease in transmittance in the near-infrared region can be prevented. The Fe-Redox is more preferably 32% or less, still more preferably 30% or less, and particularly preferably 28% or less.

The Fe-Redox can be adjusted based on a raw material composition, melting temperature, and melting atmosphere. In addition, the Fe-Redox can be adjusted by controlling a degree of oxidation-reduction of the melt of the glass by using a reducing agent such as coke or ammonium chloride as a raw material.

The glass according to the present embodiment may contain components other than the above components (hereinafter, also referred to as “other components”).

Examples of the other components include CeO₂, Nd₂O₅, GaO₂, GeO₂, MnO₂, NiO, Cr₂O₃, V₂O₅, Au₂O₃, Ag₂O, CuO, CdO, MoO₃, SO₃, Cl, F, SnO₂, and Sb₂O₃, and the other components may be a metal ion or an oxide. The other components may be contained in an amount of, for example, 3.0% or less in total for various purposes (for example, fining, coloring, or chemical durability). In the case where the total content of the other components is 3.0% or less, the glass can maintain properties necessary for a vehicular glass or a cover glass for sensors such as a LiDAR. The total content of the other components is preferably 2.5% or less, more preferably 2.0% or less, still more preferably 1.5% or less, particularly preferably 1.0% or less, and most preferably 0.50% or less.

In order to prevent adverse influences on the environment, the contents of As₂O₃ and PbO are each preferably less than 0.0010%, and more preferably substantially free of As₂O₃ and PbO.

In the case where the glass according to the present embodiment contains NiO, NiS may be formed to cause glass breakage, and thus the content of NiO is preferably 0.0080% or less. The content of NiO in the glass according to the present embodiment is more preferably 0.0040% or less, still more preferably 0.0020% or less, and particularly preferably substantially free of NiO.

The glass according to the present embodiment may contain CeO₂. CeO₂ has an absorption in an ultraviolet region, and thus reduces ultraviolet transmittance Tuv and improves UV cut performance. In addition, CeO₂ can act as an oxidizing agent to control the Fe-Redox. In the case where the glass according to the present embodiment contains CeO₂, the content thereof is preferably 0.010% or more, more preferably 0.020% or more, still more preferably 0.040% or more, and particularly preferably 0.070% or more. CeO₂ absorbs light in the ultraviolet region to cause solarization, and the transmittance in a visible region may be reduced. Therefore, the content of CeO₂ is preferably 0.25% or less, more preferably 0.18% or less, still more preferably 0.14% or less, and particularly preferably 0.10% or less.

The glass according to the present embodiment may contain Cr₂O₃. Cr₂O₃ can act as an oxidizing agent to control the Fe-Redox. In the case where the glass according to the present embodiment contains Cr₂O₃, the content thereof is preferably 0.0020% or more, and more preferably 0.0040% or more. Since Cr₂O₃ has coloring in light in the visible region, the visible light transmittance may be reduced. In addition, the amount of Fe²⁺ may be reduced, and heat shielding property may decrease. Therefore, in the case where the glass according to the present embodiment contains Cr₂O₃, the content thereof is preferably 0.020% or less, more preferably 0.016% or less, still more preferably 0.012% or less, and particularly preferably 0.0080% or less.

The glass according to the present embodiment may contain SnO₂. SnO₂ can act as a reducing agent to control the Fe-Redox. It also acts as a fining agent. In the case where the glass according to the present embodiment contains SnO₂, the content thereof is preferably 0.010% or more, more preferably 0.040% or more, still more preferably 0.060% or more, and particularly preferably 0.080% or more. On the other hand, in order to prevent defects derived from SnO₂ during the production of the glass, the content of SnO₂ in the glass according to the present embodiment is preferably 0.40% or less, more preferably 0.30% or less, still more preferably 0.20% or less, and particularly preferably 0.15% or less.

The glass according to the present embodiment may contain SO₃. SO₃ acts as a fining agent and therefore improves bubble quality of the glass. In the case where the glass according to the present embodiment contains SO₃, the content thereof is preferably 0.0010% or more, more preferably 0.0040% or more, still more preferably 0.0070% or more, and particularly preferably 0.015% or more. In the case where the glass has a large Fe-Redox, SO₃ may promote amber coloring, resulting in browning of the glass and reduction of visible light transmittance. In the case where the glass according to the present embodiment contains SO₃, the content thereof is preferably 0.070% or less, more preferably 0.060% or less, still more preferably 0.050% or less, and particularly preferably 0.040% or less.

The glass according to the present embodiment may contain Cl. Cl acts as a fining agent and therefore improves bubble quality of the glass. In the case where the glass according to the present embodiment contains Cl, the content thereof is preferably 0.080% or more, more preferably 0.15% or more, still more preferably 0.20% or more, particularly preferably 0.25% or more, and most preferably 0.30% or more. In the case where the content of Cl is large, Cl₂ gas volatilized from the melt of the glass may corrode surrounding members. In the case where glass according to the present embodiment contains Cl, the content thereof is preferably 1.0% or less, more preferably 0.80% or less, still more preferably 0.60% or less, and particularly preferably 0.50% or less.

### [Properties]

### (Fracture Toughness Value K_{IC})

The glass according to the present embodiment preferably has a fracture toughness value K_{IC} of 0.76 MPa·m^{1/2} or more, as measured by an SEPB method. The fracture toughness value K_{IC} is an index of the strength of the glass, and the larger the fracture toughness value K_{IC} is, the more difficult the crack progresses and the higher the cracking resistance is. Therefore, in the case where the fracture toughness value K_{IC} is 0.76 MPa·m^{1/2} or more, sufficient cracking resistance is obtained, which is suitable for a cover glass for vehicles or sensors. The fracture toughness value K_{IC} is more preferably 0.78 MPa·m^{1/2} or more, still more preferably 0.80 MPa·m^{1/2} or more, even more preferably 0.82 MPa·m^{1/2} or more, even still more preferably 0.84 MPa·m^{1/2} or more, particularly preferably 0.86 MPa·m^{1/2} or more, particularly preferably 0.88 MPa·m^{1/2} or more, and most preferably 0.90 MPa·m^{1/2} or more.

The fracture toughness value K_{IC} is measured based on JIS R1607:2015 “Testing methods for fracture toughness of fine ceramics” using a pre-crack introduction fracture test method (SEPB method: single-edge-precracked-beam method).

Examples of the method of setting the fracture toughness value within the above range include a method of increasing the content of SiO₂, a method of increasing the ratio of an alkaline earth metal component having a small element number among RO, and a method of increasing the ratio of an alkali metal component having a small element number among R₂O. Specifically, since SiO₂ is a component that forms a network structure, the structure of the glass becomes strong by increasing the content of SiO₂, and thus the fracture toughness value can be increased. In addition, as the element number of the alkaline earth metal component in RO is smaller, the Young's modulus is increased, and as a result, the fracture toughness value can be increased. As the element number of the alkali metal component in R₂O is smaller, a similar tendency to RO is shown.

The fracture toughness value K_{IC} (MPa·m^{1/2}) can be calculated based on Young's modulus E (GPa), surface fracture energy γ (J/m²), and Poisson's ratio v (no unit) according to the following equation.

$$\begin{matrix}[ Math . 1 ] & \\ {K}_{Ic} = \sqrt{2 E γ / ( 1 - {ν}^{2} )} & ( 1 )\end{matrix}$$

As shown in the above equation, the fracture toughness value K_{IC} increases as the Young's modulus E and the surface fracture energy γ increase.

### (Young's Modulus)

The glass according to the present embodiment preferably has a Young's modulus of 75 GPa or more. In the case where the Young's modulus is 75 GPa or more, the glass has high rigidity and the fracture toughness value is increased, and thus the glass is more suitable as a vehicular window glass or a cover glass for sensors such as a LiDAR. The Young's modulus of the glass according to the present embodiment is preferably 76 GPa or more, more preferably 77 GPa or more, particularly preferably 78 GPa or more, and most preferably 79 GPa or more.

In addition, the Young's modulus is preferably 87 GPa or less, more preferably 86 GPa or less, still more preferably 85 GPa or less, and particularly preferably 84 GPa or less, from the viewpoint of preventing deformation and cracking of the glass when the glass receives an external force.

Examples of the method of setting the Young's modulus within the above range include a method of adjusting the types and amounts of RO and R₂O to increase the content of MgO or Li₂O and a method of adding Y₂O₃, TiO₂, or ZrO₂. The Young's modulus can be measured by using an ultrasonic pulse method based on JIS R1602:1995 “Testing methods for elastic modulus of fine ceramics”.

### (Surface Fracture Energy)

The glass according to the present embodiment preferably has a surface fracture energy of 3.6 J/m² or more. A larger surface fracture energy is preferred since the fracture toughness value is increased. The surface fracture energy is more preferably 3.7 J/m² or more, still more preferably 3.8 J/m² or more, particularly preferably 3.9 J/m² or more, and most preferably 4.0 J/m² or more.

The surface fracture energy can be obtained by measuring the fracture toughness value, the Young's modulus, and the Poisson's ratio, and calculating based on the relational expression in the above expression (1).

### (Rigidity Modulus)

The glass according to the present embodiment preferably has a rigidity modulus of 31 GPa or more. In the case where the rigidity modulus is 31 GPa or more, the glass is less likely to be deformed when receiving an external force. The rigidity modulus of the glass is more preferably 32 GPa or more, and still more preferably 33 GPa or more.

In addition, the rigidity modulus is preferably 38 GPa or less, more preferably 37 GPa or less, still more preferably 36 GPa or less, and particularly preferably 35 GPa or less, since cracking can be prevented by deforming the glass to consume the energy when the glass receives an external force. The rigidity modulus can be measured by using an ultrasonic pulse method based on JIS R1602:1995 “Testing methods for elastic modulus of fine ceramics”.

### (Poisson's Ratio)

The glass according to the present embodiment preferably has a Poisson's ratio of 0.26 or less. In the case where the Poisson's ratio is 0.26 or less, a stress generated when an external force is applied to the glass can be reduced. The fracture toughness value can also be increased. The Poisson's ratio is more preferably 0.25 or less, still more preferably 0.24 or less, and particularly preferably 0.23 or less.

The Poisson's ratio can be measured by using an ultrasonic pulse method based on JIS R1602:1995 “Testing methods for elastic modulus of fine ceramics”.

### (T₂)

In the glass according to the present embodiment, a temperature T₂ at which the glass viscosity η is 10² [dPa·s], which is a reference for the meltability of the glass, is preferably 1650° C. or lower. In the case where the T₂ is 1650° C. or lower, consumption of fuel used during melting of the raw material of the glass can be reduced, and the lifetime of a brick member used in the melting furnace can be extended.

Examples of the method of setting the T₂ to 1650° C. or lower include a method of increasing the contents of R₂O and RO and reducing the content of Al₂O₃ in components of the glass, a method of containing Li₂O among R₂O, and a method of reducing the content of SiO₂.

The T₂ is more preferably 1600° C. or lower, still more preferably 1575° C. or lower, even more preferably 1550° C. or lower, particularly preferably 1525° C. or lower, and most preferably 1500° C. or lower. In addition, the T₂ is preferably 1400° C. or higher, more preferably 1425° C. or higher, and still more preferably 1450° C. or higher, from the viewpoint of maintaining fracture toughness of the glass and from the viewpoint of preventing average linear expansion coefficient of the glass from being too large.

### (T₄)

In the glass according to the present embodiment, a temperature T₄ at which the glass viscosity η is 10⁴ [dPa·s], which is a reference for the formability during float forming, is preferably 1200° C. or lower. In the case where the T₄ of 1200° C. or lower, the glass is suitable for plate forming by using a float method.

Examples of the method of setting the T₄ to 1200° C. or lower include a method of increasing the contents of R₂O and RO and reducing the content of Al₂O₃ in components of the glass, a method of containing Li₂O among R₂O, and a method of reducing the content of SiO₂.

The T₄ is more preferably 1175° C. or lower, still more preferably 1150° C. or lower, even more preferably 1125° C. or lower, particularly preferably 1100° C. or lower, and most preferably 1075° C. or lower. In addition, the T₄ is preferably 950° C. or higher, more preferably 975° C. or higher, still more preferably 1000° C. or higher, and particularly preferably 1025° C. or higher, from the viewpoint of maintaining fracture toughness of the glass and from the viewpoint of preventing average linear expansion coefficient of the glass from being too large.

### (T₁₁)

In the glass according to the present embodiment, a temperature T₁₁ at which the glass viscosity η is 10¹¹ [dPa·s], which is a reference for the bending workability, is preferably 640° C. or lower. In the case where the T₁₁ is 640° C. or lower, it is possible to perform bending forming at a low temperature.

Examples of the method of setting the T₁₁ to 640° C. or lower include a method of increasing the contents of R₂O and RO and reducing the content of Al₂O₃ in components of the glass, a method of containing Li₂O among R₂O, and a method of reducing the content of SiO₂.

In the glass according to the present embodiment, the T₁₁ is more preferably 635° C. or lower, still more preferably 630° C. or lower, even more preferably 625° C. or lower, even still more preferably 620° C. or lower, particularly preferably 615° C. or lower, and most preferably 610° C. or lower.

In addition, the T₁₁ is preferably 570° C. or higher, more preferably 575° C. or higher, still more preferably 580° C. or higher, particularly preferably 585° C. or higher, and most preferably 590° C. or higher, from the viewpoint of maintaining fracture toughness of the glass, from the viewpoint of preventing average linear expansion coefficient of the glass from being too large, and from the viewpoint of firing temperature of a black ceramic to be printed on a windshield.

### (T₁₂)

In the glass according to the present embodiment, a temperature T₁₂ at which the glass viscosity η is 10¹² [dPa·s], which is a reference for the bending workability, is preferably 610° C. or lower. In the case where the T₁₂ is 610° C. or lower, it is possible to perform bending forming at a low temperature.

Examples of the method of setting the T₁₂ to 610° C. or lower include a method of increasing the contents of R₂O and RO and reducing the content of Al₂O₃ in components of the glass, a method of containing Li₂O among R₂O, and a method of reducing the content of SiO₂.

The T₁₂ is more preferably 605° C. or lower, still more preferably 600° C. or lower, even more preferably 595° C. or lower, even still more preferably 590° C. or lower, particularly preferably 585° C. or lower, and most preferably 580° C. or lower. In addition, the T₁₂ is preferably 540° C. or higher, more preferably 545° C. or higher, still more preferably 550° C. or higher, particularly preferably 555° C. or higher, and most preferably 560° C. or higher, from the viewpoint of maintaining fracture toughness of the glass, from the viewpoint of preventing average linear expansion coefficient of the glass from being too large, and from the viewpoint of firing temperature of a black ceramic to be printed on a windshield.

### (Density)

The glass according to the present embodiment preferably has a density of 2.68 g/cm³ or less. In the case where the density is 2.68 g/cm³ or less, it is possible to increase the Young's modulus and the fracture toughness value, and to improve sound insulation property and the like, while preventing an increase in fuel efficiency and electric efficiency due to an increase in weight. In general, a glass having a high Young's modulus and a high fracture toughness value has a high density and is likely to have a high bending forming temperature, but by adjusting the compositions and contents of R₂O and RO in components of the glass, a high Young's modulus, a high fracture toughness value, and excellent bending formability can be achieved while reducing the density.

The density of the glass according to the present embodiment is more preferably 2.66 g/cm³ or less, still more preferably 2.60 g/cm³ or less, even more preferably 2.55 g/cm³ or less, even still more preferably 2.53 g/cm³ or less, particularly preferably 2.51 g/cm³ or less, and most preferably 2.49 g/cm³ or less.

In addition, the density of the glass according to the present embodiment is preferably 2.40 g/cm³ or more, more preferably 2.42 g/cm³ or more, particularly preferably 2.43 g/cm³ or more, and most preferably 2.44 g/cm³ or more, from the viewpoint of improving sound insulation property.

### (T_{g})

The glass according to the present embodiment preferably has a glass transition temperature (T_{g}) in a range of 460° C. or higher and lower than 600° C. In the case where the T_{g} is within this predetermined temperature range, the glass can be bent within general production condition ranges. In the case where the T_{g} of the glass according to the present embodiment is 460° C. or higher, the content of the alkali metal or the content of the alkaline earth metal is not too large, and an increase in average linear expansion coefficient of the glass can be prevented. In addition, moisture resistance can be improved, devitrification of the glass can be prevented, and formability can be improved. The T_{g} is more preferably 480° C. or higher, still more preferably 490° C. or higher, and particularly preferably 500° C. or higher.

In addition, the T_{g} is preferably lower than 600° C., more preferably 590° C. or lower, still more preferably 585° C. or lower, even more preferably 580° C. or lower, particularly preferably 575° C. or lower, and most preferably 570° C. or lower, from the viewpoint of preventing bending forming temperature of the glass from being excessively high and of facilitating the production.

### (Yield Point)

The glass according to the present embodiment preferably has a yield point of 670° C. or lower. In the case where the yield point is within the above range, excellent bending formability is obtained. The yield point of the glass is more preferably 660° C. or lower, still more preferably 650° C. or lower, particularly preferably 640° C. or lower, and most preferably 630° C. or lower.

In addition, the yield point is preferably 580° C. or higher. In the case where the yield point is 580° C. or higher, the bending forming temperature can be prevented from being too low, and a black ceramic to be printed on a windshield can be fired simultaneously with the bending forming. The yield point is more preferably 585° C. or higher, still more preferably 590° C. or higher, particularly preferably 595° C. or higher, and most preferably 600° C. or higher. The yield point can be measured by using a differential thermal dilatometer (TMA).

### (Average Linear Expansion Coefficient)

The glass according to the present embodiment preferably has an average linear expansion coefficient (CTE) of 100×10⁻⁷/° C. or less at 50° C. to 350° C. In the case where the average linear expansion coefficient is 100×10⁻⁷/° C. or less, cracking due to heat shock can be prevented in the case where the glass according to the present embodiment is used as a glass for vehicles or sensors. In addition, in the case where the glass according to the present embodiment is a bent glass, a difference in thermal expansion due to a difference in in-plane thermal history can be prevented, and a bent glass having a good dimension and surface accuracy can be obtained.

The average linear expansion coefficient of the glass according to the present embodiment at 50° C. to 350° C. is preferably 100×10⁻⁷/° C. or less, more preferably 95×10⁻⁷/° C. or less, still more preferably 92×10⁻⁷/° C. or less, and particularly preferably 90×10⁻⁷/° C. or less.

In addition, the glass according to the present embodiment preferably has an average linear expansion coefficient of 70×10⁻⁷/° C. or more, from the viewpoint of preventing cracking of a black ceramic due to a difference in thermal expansion from a black ceramic to be printed on a windshield. In the case where the average linear expansion coefficient is 70×10⁻⁷/° C. or more, the difference in thermal expansion from the black ceramic is small, and the cracking of the black ceramic can be prevented. The average linear expansion coefficient is more preferably 72×10⁻⁷/° C. or more, still more preferably 74×10⁻⁷/° C. or more, particularly preferably 76×10⁻⁷/C or more, particularly preferably 78×10⁻⁷/° C. or more, particularly preferably 80×10⁻⁷/C or more, and most preferably 82×10⁻⁷/° C. or more.

Examples of the method of setting the average linear expansion coefficient within the above range includes a method of increasing the content of SiO₂ and adjusting the contents of R₂O, RO and Al₂O₃ in components of the glass.

### (Solar Transmittance: Te)

In the case where the glass according to the present embodiment is used as a vehicular glass, the glass according to the present embodiment preferably has a solar transmittance Te of 90% or less as defined in ISO-9050:2003 in terms of a thickness of 2.00 mm. In the case where the Te is 90% or less, an excellent heat shielding property can be obtained. The Te is more preferably 88% or less, still more preferably 86% or less, even more preferably 84% or less, particularly preferably 82% or less, and most preferably 80% or less. The Te is not particularly limited in lower limit, and is generally 30% or more, preferably 32% or more, more preferably 34% or more, and particularly preferably 36% or more. The above range of the Te can be achieved by adjusting the content of Fe₂O₃ to 0.030% or more.

### (Visible Light Transmittance: Tv)

In the case where the glass according to the present embodiment is used as a vehicular glass, the glass according to the present embodiment preferably has a visible light transmittance Tv of 75% or more, as calculated by measuring the transmittance with a spectrophotometer using a D65 light source according to the provisions in ISO-9050:2003 in terms of a thickness of 2.00 mm. In the case where the Tv is 75% or more, the glass has excellent transparency and is thus more suitable for use as a vehicular glass, particularly, a windshield or a door glass. The Tv is more preferably 78% or more, still more preferably 80% or more, even more preferably 82% or more, particularly preferably 84% or more, and most preferably 86% or more. The Tv is not particularly limited in upper limit, and is, for example, 92% or less.

The above range of the Tv can be achieved by adjusting the glass composition, particularly the content of SiO₂ or Fe₂O₃.

### (Ultraviolet Transmittance: Tuv)

In the case where the glass according to the present embodiment is used as a vehicular glass, the glass according to the present embodiment preferably has low ultraviolet transmissibility, and preferably has an ultraviolet transmittance Tuv of 70% or less as defined in ISO-9050:2003 in terms of a thickness of 2.00 mm. In the case where the Tuv is 70% or less, deterioration of members such as a seat in a vehicle interior and an interlayer when the glass according to the present embodiment is used as a laminated glass can be prevented. The Tuv is more preferably 68% or less, still more preferably 66% or less, even more preferably 64% or less, particularly preferably 62% or less, and most preferably 60% or less. In addition, the lower limit of the Tuv is, for example, 10% or more.

The above range of the Tuv can be achieved by adjusting the glass composition, particularly SiO₂, Fe₂O₃, TiO₂, CeO₂, or Fe-Redox.

In the case where the glass according to the present embodiment is used as a cover glass for a LiDAR, the glass according to the present embodiment preferably has a high transmittance at a wavelength of 905 nm or 1550 nm used in the LiDAR. Therefore, in the glass according to the present embodiment, the transmittance at a wavelength of 905 nm or 1550 nm in terms of a thickness of 4.0 mm is preferably 86% or more, more preferably 87% or more, still more preferably 88% or more, even more preferably 89% or more, particularly preferably 90% or more, and most preferably 91% or more.

The shape of the glass according to the present embodiment is not particularly limited, and in the case where the glass according to the present embodiment is used as a vehicular glass, the area of a main surface is preferably 0.25 m² or more, more preferably 0.45 m² or more, and still more preferably 0.90 m² or more. In the case where the area of the glass is within the above range, the glass can be suitable for various vehicle types. In addition, in the case where the area of the glass is too large, difficulty of the bending forming increases, such as difficulty in handling, non-uniformity of temperature distribution during heating, and deterioration of dimensional accuracy after the bending forming. Therefore, the area of the main surface of the glass according to the present embodiment is preferably 10 m² or less, more preferably 7 m² or less, and still more preferably 5 m² or less.

In the case where the glass according to the present embodiment is used as a cover glass for sensors, the shape of the glass according to the present embodiment is not particularly limited, and the area of the main surface is preferably 0.00010 m² or more, more preferably 0.010 m² or more, still more preferably 0.020 m² or more, particularly preferably 0.040 m² or more, and most preferably 0.090 m² or more. In the case where the area of the glass is within the above range, it is possible to cope with cover glasses for various LiDARs. In addition, in the case where the area of the glass is too large, difficulty of the bending forming increases, such as non-uniformity of temperature distribution during heating, and deterioration of dimensional accuracy after the bending forming. Therefore, the area of the main surface of the glass according to the present embodiment is preferably 1.0 m² or less, more preferably 0.90 m² or less, and still more preferably 0.80 m² or less.

The glass according to the present embodiment preferably has a critical collision fracture rate of 35 km/h or more upon collision with a tungsten carbide superhard alloy having a tip curvature radius of 200 μm, an apex angle of 120°, and a weight of 1.365 g, when the glass has a surface roughness Ra of 5.0 nm or less and a thickness of 2.5 mm. In the case where the critical collision fracture rate is 35 km/h or more, flying stone resistance can be improved. The critical collision fracture rate is more preferably 36 km/h or more, still more preferably 37 km/h or more, even more preferably 38 km/h or more, even still more preferably 39 km/h or more, particularly preferably 40 km/h or more, and most preferably 42 km/h or more. The upper limit of the critical collision fracture rate is, for example, 120 km/h or less. Note that, the surface roughness Ra can be measured based on JIS B0601:2001.

The glass according to the embodiment preferably has a critical collision fracture rate of 53 km/h or more upon collision on the glass with a tungsten carbide superhard alloy having a tip curvature radius of 200 μm, an apex angle of 120°, and a weight of 1.365 g. In the case where the critical collision fracture rate is 53 km/h or more, flying stone resistance can be improved. The critical collision fracture rate is more preferably 54 km/h or more, still more preferably 55 km/h or more, and particularly preferably 56 km/h or more. The upper limit of the critical collision fracture rate is, for example, 120 km/h or less. The critical collision fracture rate can be measured by the method described in Examples to be described later.

The glass according to the present embodiment preferably has a thickness of 2.5 mm or more. In particular, in the case where the glass according to the present embodiment has the above properties, the thickness of the glass is preferably 2.5 mm or more. In the case where the thickness of the glass is 2.5 mm or more, the critical collision fracture rate of the glass having a high fracture toughness value can be improved. The thickness of the glass is more preferably 2.8 mm or more, still more preferably 2.9 mm or more, even more preferably 3.0 mm or more, even still more preferably 3.1 mm or more, yet more preferably 3.2 mm or more, yet still more preferably 3.3 mm or more, particularly preferably 3.4 mm or more, and most preferably 3.5 mm or more.

In addition, the thickness of the glass according to the present embodiment is preferably 6.0 mm or less, more preferably 5.5 mm or less, still more preferably 5.0 mm or less, particularly preferably 4.8 mm or less, and most preferably 4.5 mm or less, from the viewpoint of preventing an increase in fuel efficiency and electric efficiency due to an increase in weight of the glass.

Note that, examples of the method of adjusting the thickness of the glass include a method of adjusting the thickness of the glass by using a float method or a down draw method, to be described later, and a method of polishing the glass in a thickness direction by using a grindstone and then performing mirror-finishing by using an abrasive such as cerium oxide. The surface roughness Ra after forming or polishing is preferably 5.0 nm or less, more preferably 2.0 nm or less, still more preferably 1.5 nm or less, particularly preferably 1.0 nm or less, and most preferably 0.50 nm or less.

In addition, the glass according to the present embodiment is preferably, for example, a float glass formed by using a known float method. In the float method, a molten glass base material is floated on a molten metal such as tin, and with a precise temperature control operation, it is possible to form a glass having a uniform thickness and width, and to obtain a glass having a large area.

In addition, the glass according to the present embodiment may be a glass formed by using a known roll-out method or down draw method, or a glass having a polished surface and a uniform thickness. Here, the down draw method is roughly classified into a slot down draw method and an overflow down draw method (fusion method), and both are methods in which a molten glass is continuously poured down from a forming body to form a glass ribbon in a band plate shape.

The glass according to the present embodiment may be a glass subjected to a strengthening treatment such as air-cooling strengthening or chemical strengthening. With the above treatment, the strength of the glass can be increased.

Here, the air-cooling strengthening is a treatment of forming a compressive stress layer on the surface of the glass by a thermal strengthening treatment. Specifically, a uniformly heated glass is rapidly cooled from a temperature near the softening point to generate a compressive stress on the surface of the glass due to a temperature difference between the surface and the inside of the glass. The compressive stress is generated uniformly over the entire surface of the glass, and a compressive stress layer having a uniform depth is formed over the entire surface of the glass. The thermal strengthening treatment is more suitable for strengthening a thick glass than a chemical strengthening treatment.

In addition, the chemical strengthening is a treatment in which alkali metal ions having a smaller ion radius (typically, Li ions or Na ions) on the surface of the glass are exchanged by alkali metal ions having a larger ion radius (typically, Na ions or K ions) through ion exchange at a temperature equal to or lower than the glass transition point, thereby forming a compressive stress layer on the surface of the glass. The chemical strengthening treatment can be performed by using a known method, for example, an ion exchange method. In the ion exchange method, a glass plate is immersed in a treatment solution (for example, a potassium nitrate molten salt), and ions having a smaller ion radius (for example, Na ions) contained in the glass are exchanged for ions having a larger ion radius (for example, K ions), thereby forming a compressive stress on the surface of the glass.

Each of a magnitude of the compressive stress on the surface of the glass (hereinafter, also referred to as a surface compressive stress CS) and a depth DOL of the compressive stress layer formed on the surface of the glass can be adjusted based on the glass composition, an immersion time in the treatment solution, and a temperature of the treatment solution.

The glass according to the present embodiment may have a flat plate shape, or may be a bent glass formed into a curved shape by gravity forming, press forming, or the like.

In the case where the glass according to the present embodiment is a glass that curves with a predetermined curvature, it may be a single bent glass that curves only in one direction, either an up-and-down direction or a right-and-left direction, or may be a multi-bent glass that curves both in the up-and-down direction and the right-and-left direction.

In the case where the glass according to the present embodiment is a bent glass, it preferably has a minimum curvature radius of 500 mm or more and 100,000 mm or less. Regarding the curvature radius of the bent glass, the shape of a sample is calculated by a shape simulation using a laser displacement meter (Dyvoce manufactured by Kohzu Precision Co., Ltd.) based on the amount of warpage inherent in the sample, which is determined by self-weight deflection correction in a double-sided difference mode, and the curvature radius is determined based on the shape obtained by the simulation.

The glass according to the present embodiment can be formed into a bent glass by heating and bending the glass. Specific examples of the forming method include a method of heating a flat plate-shaped glass, and, in a state of being placed in a mold, pressing the heated glass to bending forming from above by using a press.

Other examples include a method of placing a flat plate-shaped glass on a mold having a bending forming surface corresponding to a desired curved surface, carrying the mold into a heating furnace in this state, and heating the glass in the heating furnace to a temperature near the softening point of the glass. According to this forming method, since the glass curves along the bending forming surface of the mold due to the own weight along with softening, a bent glass having a desired curved surface is produced.

In the present embodiment, from the viewpoint of improving productivity and improving surface accuracy after forming, the above-described bending forming using a press is preferred. The above bending forming method using a press is not particularly limited, and for example, the method described in WO 2016/093031 can be used as appropriate. Hereinafter, the above bending forming method using a press is described by way of example.

First, the glass according to the present embodiment is transported to a press area by using a transport conveyor or the like. Next, in the press area, the glass is softened by heating it to a temperature at which bending forming can be performed.

Here, the temperature at which bending forming can be performed is, for example, equal to or higher than the temperature T₁₂ at which the glass viscosity is 10¹² [dPa·s]. Note that, the heating may be performed by using a heater or the like in the heating furnace in the process of transporting the glass to the press area by using the transport conveyor or the like.

In addition, the bending forming time under the condition that the heating temperature (≥T₁₂) is maintained can be set to, for example, 1 second or longer.

A lower press mold (female mold) and an upper press mold (male mold) are disposed at predetermined positions in the press area, and an upper surface shape of the female mold and a lower surface shape of the male mold correspond to the curved shape of the glass to be subjected to the bending forming in a transporting direction and an orthogonal direction. The female mold can be moved up and down between a standby position below the transport conveyor and a press position above the transport conveyor, and after the glass is transferred from the transport conveyor, the female mold is moved up from a predetermined raised position to the press position above the transport conveyor with the glass placed thereon, whereby the glass is subjected to press forming.

Next, the press-formed glass is transported to a cooling area by using a transport shuttle or the like. In the cooling area, the glass is cooled by, for example, blowing cooling air to the glass.

With the above steps, a bent glass can be formed. Note that, although the bending forming of the glass according to the present embodiment has been described above, the bending forming may also be performed in the state of a laminated glass, to be described later.

### [Laminated Glass]

A laminated glass according to the present embodiment includes a first glass plate, a second glass plate, and an interlayer sandwiched between the first glass plate and the second glass plate, and the first glass plate is the glass according to the present embodiment.

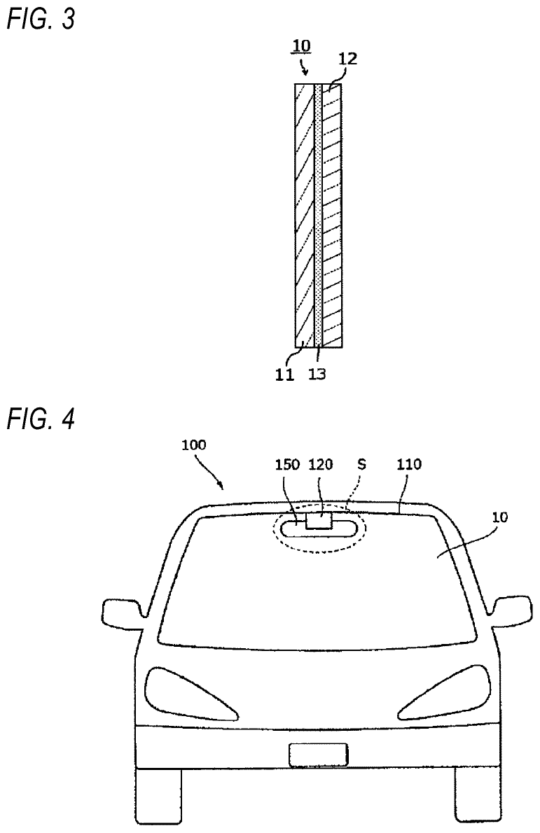

FIG. 3 is a view illustrating an example of a laminated glass 10 according to the present embodiment. The laminated glass 10 includes a first glass plate 11, a second glass plate 12, and an interlayer 13 sandwiched between the first glass plate 11 and the second glass plate 12. Note that, the laminated glass 10 according to the present embodiment is not limited to the aspect in FIG. 3, and can be modified without departing from the gist of the present invention. For example, the interlayer 13 may be formed as one layer as illustrated in FIG. 3, or may be formed as two or more layers. In addition, the laminated glass 10 according to the present embodiment may include three or more glass plates, and in this case, an organic resin or the like may be interposed between adjacent glass plates. Hereinafter, the laminated glass 10 according to the present embodiment is described as a configuration in which only two glass plates, that is, the first glass plate 11 and the second glass plate 12, are included, and the interlayer 13 is sandwiched therebetween.

In the laminated glass according to the present embodiment, the second glass plate 12 is preferably the glass according to the present embodiment from the viewpoint of the bending formability. In the case where the first glass plate 11 and the second glass plate 12 are each the glass according to the present embodiment, glass plates having the same composition or glass plates having different compositions may be used as the first glass plate 11 and the second glass plate 12.

In the case where the second glass plate 12 is not the glass according to the present embodiment, the type of the glass plate is not particularly limited, and a known glass plate in the related art used for a vehicular window glass can be used. Specific examples thereof include an alkali aluminosilicate glass, an alkali aluminoborosilicate glass, and a soda lime glass. These glass plates may be colored to such an extent that the transparency thereof is not impaired, or may not be colored.

In the present embodiment, the second glass plate 12 may be an alkali aluminosilicate glass containing 1.0% or more of Al₂O₃, or may be an alkali aluminoborosilicate glass containing 1.0% or more of Al₂O₃ and 1.0% or more of B₂O₃. By using the above alkali aluminosilicate glass or alkali aluminoborosilicate glass as the second glass plate 12, chemical strengthening to be described later can be performed, and the strength can be increased.

In the above alkali aluminosilicate glass and alkali aluminoborosilicate glass, the content of Al₂O₃ is more preferably 5.0% or more, still more preferably 8.0% or more, and particularly preferably 10% or more, from the viewpoint of improving weather resistance, moisture resistance, and chemical strengthening properties. In addition, the content of Al₂O₃ is preferably 18% or less, and more preferably 15% or less, from the viewpoint of reducing the viscosity of the glass and making it easier to produce.

In the above alkali aluminosilicate glass and alkali aluminoborosilicate glass, the content of R₂O is preferably 10% or more, more preferably 12% or more, and still more preferably 13% or more, from the viewpoint of chemical strengthening. In addition, the content of R₂O is preferably 22% or less, more preferably 20% or less, and still more preferably 18% or less, from the viewpoint of improving moisture resistance.

In the above alkali aluminoborosilicate glass, the content of B₂O₃ is preferably 2.0% or more, more preferably 3.0% or more, and still more preferably 4.0% or more, in order to increase the strength when the glass comes into contact with flying stones, vehicle keys, or the like. In addition, in the alkali aluminoborosilicate glass, the content of B₂O₃ is preferably 9.0% or less, more preferably 8.0% or less, and still more preferably 7.0% or less, from the viewpoint of improving chemical durability and weather resistance.

Specific examples of the above alkali aluminosilicate glass include a glass having the following composition. Each component is expressed in mol % in terms of oxides.

$$\begin{matrix}61 \% \leq {SiO}_{2} \leq 75 \% , \\ 1. \% \leq {Al}_{2} {O}_{3} \leq 20 \% , \\ 0. \% \leq MgO \leq 15 \% , \\ 0. \% \leq CaO \leq 10 \% , \\ 0. \% \leq SrO \leq 1. \% , \\ 0. \% \leq BaO \leq 1. \% , \\ 0. \% \leq {Li}_{2} O \leq 15 \% , \\ 2. \% \leq {Na}_{2} O \leq 15 \% , \\ 0. \% \leq {K}_{2} O \leq 6. \% , \\ 0. \% \leq {ZrO}_{2} \leq 4. \% , \\ 0. \% \leq {TiO}_{2} \leq 1. \% , \\ 0. \% \leq {Y}_{2} {O}_{3} \leq 2. \% , \\ 10 \% \leq {R}_{2} O \leq 25 \% , and \\ 0. \% \leq RO \leq 20 \% ,\end{matrix}$$

(R₂O represents the total content of Li₂O, Na₂O, and K₂O, and RO represents the total content of MgO, CaO, SrO, and BaO.)

Specific examples of the above alkali aluminoborosilicate glass include a glass having the following composition. Each component is expressed in mol % in terms of oxides.

$$\begin{matrix}61 \% \leq {SiO}_{2} \leq 75 \% , \\ 1. \% \leq {Al}_{2} {O}_{3} \leq 20 \% , \\ 1. \% \leq {B}_{2} {O}_{3} \leq 10 \% , \\ 0. \% \leq MgO \leq 15 \% , \\ 0. \% \leq CaO \leq 10 \% , \\ 0. \% \leq SrO \leq 1. \% , \\ 0. \% \leq BaO \leq 1. \% , \\ 0. \% \leq {Li}_{2} O \leq 15 \% , \\ 2. \% \leq {Na}_{2} O \leq 15 \% , \\ 0. \% \leq {K}_{2} O \leq 6. \% , \\ 0. \% \leq {ZrO}_{2} \leq 4. \% , \\ 0. \% \leq {TiO}_{2} \leq 1. \% , \\ 0. \% \leq {Y}_{2} {O}_{3} \leq 2. \% , \\ 10 \% \leq {R}_{2} O \leq 25 \% , and \\ 0. \% \leq RO \leq 20 \%\end{matrix}$$

(R₂O represents the total content of Li₂O, Na₂O, and K₂O, and RO represents the total content of MgO, CaO, SrO, and BaO.)

In addition, in the laminated glass according to the present embodiment, the second glass plate 12 may be a soda lime glass. The soda lime glass may be a soda lime glass containing 3.5% or less of Al₂O₃. Specific examples thereof include a glass having the following composition. Each component is expressed in mol % in terms of oxides.

$$\begin{matrix}60 \% \leq {SiO}_{2} \leq 75 \% , \\ 0. \% \leq {Al}_{2} {O}_{3} \leq 3.5 \% , \\ 2. \% \leq MgO \leq 11 \% , \\ 2. \% \leq CaO \leq 10 \% , \\ 0. \% \leq SrO \leq 3. \% , \\ 0. \% \leq BaO \leq 3. \% , \\ 10 \% \leq {Na}_{2} O \leq 18 \% , \\ 0. \% \leq {K}_{2} O \leq 8. \% , \\ 0. \% \leq {ZrO}_{2} \leq 4. \% , and \\ 0.001 \% \leq {Fe}_{2} {O}_{3} \leq 5. \% .\end{matrix}$$

The thickness of the first glass plate 11 is preferably 2.5 mm or more. In the case where the thickness of the first glass plate 11 is 2.5 mm or more, the critical collision fracture rate of the glass having a high fracture toughness value can be improved. The thickness of the first glass plate 11 is more preferably 2.8 mm or more, still more preferably 2.9 mm or more, even more preferably 3.0 mm or more, even still more preferably 3.1 mm or more, yet more preferably 3.2 mm or more, yet still more preferably 3.3 mm or more, particularly preferably 3.4 mm or more, and most preferably 3.5 mm or more.

In addition, the thickness of the first glass plate 11 is preferably 6.0 mm or less, more preferably 5.5 mm or less, still more preferably 5.0 mm or less, particularly preferably 4.8 mm or less, and most preferably 4.5 mm or less, from the viewpoint of preventing an increase in fuel efficiency and electric efficiency due to an increase in weight of the glass.

The thickness of the second glass plate 12 is preferably 0.50 mm or more, more preferably 0.60 mm or more, still more preferably 0.70 mm or more, particularly preferably 0.80 mm or more, particularly preferably 0.90 mm or more, and most preferably 1.0 mm or more. The thickness of the second glass plate 12 is preferably 0.50 mm or more from the viewpoint of impact resistance.

In addition, the thickness of the second glass plate 12 is preferably 2.0 mm or less, more preferably 1.9 mm or less, still more preferably 1.8 mm or less, particularly preferably 1.7 mm or less, particularly preferably 1.6 mm or less, and most preferably 1.5 mm or less. In the case where the thickness of the second glass plate 12 is 2.0 mm or less, the weight of the laminated glass 10 is not too large, which is preferred from the viewpoint of improving fuel efficiency in the case of being used for a vehicle.

The first glass plate 11 and the second glass plate 12 may have the same thickness or different thicknesses, and the first glass plate 11 is preferably thicker than the second glass plate 12. Note that, examples of the method of adjusting the thickness of the first glass plate 11 and the second glass plate 12 include a method of adjusting the thickness of the glass by using a float method or a down draw method, and a method of polishing the glass in a thickness direction by using a grindstone and then performing mirror-finishing using an abrasive such as cerium oxide. The surface roughness Ra after forming or polishing is preferably 5.0 nm or less, more preferably 2.0 nm or less, still more preferably 1.5 nm or less, particularly preferably 1.0 nm or less, and most preferably 0.50 nm or less.

In the laminated glass 10 according to the present embodiment, the thicknesses of the first glass plate 11 and the second glass plate 12 may be constant over the entire surface, or may be changed for each portion as necessary, such as forming a wedge shape in which the thickness of one or both of the first glass plate 11 and the second glass plate 12 gradually decreases.

At least one of the first glass plate 11 and the second glass plate 12 may be a chemically strengthened glass subjected to glass strengthening in order to increase the strength. The method of the chemical strengthening treatment is the same as the chemical strengthening treatment for the glass described above. Examples of the chemically strengthened glass include the above alkali aluminosilicate glass and the above alkali aluminoborosilicate glass that have been subjected to a chemical strengthening treatment.

The shape of the first glass plate 11 and the second glass plate 12 may be a flat plate shape, or may be a curved shape having a curvature on the entire surface or a part thereof. In the case where the first glass plate 11 and the second glass plate 12 are curved, the first glass plate 11 and the second glass plate 12 may have a single bent shape that curves only in one direction of either the up-and-down direction or the right-and-left direction, or may have a multi-bent shape that curves both in the up-and-down direction and the right-and-left direction. In the case where the first glass plate 11 and the second glass plate 12 have a multi-bent shape, the curvature radii thereof may be same or different in the up-and-down direction and the right-and-left direction. In the case where the first glass plate 11 and the second glass plate 12 are curved, the curvature radius in the up-and-down direction and/or the right-and-left direction is preferably 1000 mm or more. The shape of the main surface of the first glass plate 11 and the second glass plate 12 is a shape that fits a window opening of a vehicle on which the laminated glass is to be mounted.

The interlayer 13 is sandwiched between the first glass plate 11 and the second glass plate 12. Since the laminated glass 10 according to the present embodiment includes the interlayer 13, the first glass plate 11 and the second glass plate 12 firmly adhere to each other, and an impact force when scattered pieces collide with the glass plates can be reduced.

As the interlayer 13, various organic resins generally used for a laminated glass used as a vehicular laminated glass in the related art can be used. As the organic resin, for example, a polyethylene (PE), an ethylene vinyl acetate copolymer (EVA), a polypropylene (PP), a polystyrene (PS), a methacrylic resin (PMA), polyvinyl chloride (PVC), a polyethylene terephthalate (PET), a polybutylene terephthalate (PBT), cellulose acetate (CA), a diallyl phthalate resin (DAP), a urea resin (UP), a melamine resin (MF), an unsaturated polyester (UP), a polyvinyl butyral (PVB), polyvinyl formal (PVF), polyvinyl alcohol (PVAL), a vinyl acetate resin (PVAc), an ionomer (IO), a polymethylpentene (TPX), a vinylidene chloride (PVDC), a polysulfone (PSF), a polyvinylidene difluoride (PVDF), a methacrylate-styrene copolymer resin (MS), a polyarylate (PAR), a polyarylsulfone (PASF), a polybutadiene (BR), a polyethersulfone (PESF), a polyether ether ketone (PEEK), or the like can be used. Among these, EVA and PVB are suitable from the viewpoint of transparency and adhesion, and particularly, PVB is more preferred since PVB can provide sound insulation property.

The thickness of the interlayer 13 is preferably 0.300 mm or more, more preferably 0.500 mm or more, and still more preferably 0.700 mm or more, from the viewpoint of a reduction in impact force and sound insulation property. In addition, the thickness of the interlayer 13 is preferably 1.00 mm or less, more preferably 0.900 mm or less, and still more preferably 0.800 mm or less, from the viewpoint of preventing a decrease in visible light transmittance. In addition, the thickness of the interlayer 13 is preferably in a range of 0.300 mm to 1.00 mm, and more preferably in a range of 0.700 mm to 0.800 mm.

The thickness of the interlayer 13 may be constant over the entire surface, or may be changed for each portion as necessary.

Note that, in the case where a difference in linear expansion coefficient between the interlayer 13 and the first glass plate 11 or the second glass plate 12 is large, when the laminated glass 10 is prepared through a heating step to be described later, the laminated glass 10 may be cracked or warped, resulting in a poor appearance. Therefore, the difference in linear expansion coefficient between the interlayer 13 and the first glass plate 11 or the second glass plate 12 is preferably as small as possible. The difference in linear expansion coefficient between the interlayer 13 and the first glass plate 11 or the second glass plate 12 may be represented by a difference between average linear expansion coefficients in a predetermined temperature range.

Particularly, since a resin constituting the interlayer 13 has a low glass transition point, a predetermined average linear expansion coefficient difference may be set in a temperature range equal to or lower than the glass transition point of the resin material. Note that, the difference in linear expansion coefficient between the resin material and the first glass plate 11 or the second glass plate 12 may be set at a predetermined temperature equal to or lower than the glass transition point of the resin material.

As the interlayer 13, an adhesive layer containing an adhesive may be used, and the adhesive is not particularly limited, and for example, an acrylic adhesive or a silicone adhesive can be used.

In the case where the interlayer 13 is an adhesive layer, it is not necessary to perform a heating step in the process of bonding the first glass plate 11 and the second glass plate 12, and thus the above cracking or warpage is less likely to occur.

### [Other Layers]

The laminated glass 10 according to the present embodiment may include layers other than the first glass plate 11, the second glass plate 12, and the interlayer 13 (hereinafter, also referred to as “other layers”) within a range that does not impair effects of the present invention. For example, a coating layer that provides a water repellent function, a hydrophilic function, an anti-fogging function, or the like, or an infrared reflection film may be provided.

Positions where the other layers are provided are not particularly limited, and the other layers may be provided on a surface of the laminated glass 10, or may be sandwiched among the first glass plate 11, the second glass plate 12, and the interlayer 13. In addition, the laminated glass 10 according to the present embodiment may include a black ceramic layer or the like which is disposed in a band shape on a part or all of a peripheral edge portion for the purpose of hiding an attachment portion to a frame body or the like, a wiring conductor, or the like.

The laminated glass 10 according to the present embodiment preferably has a critical collision fracture rate of 35 km/h or more upon collision on a surface of the first glass plate 11 with a tungsten carbide superhard alloy having a tip curvature radius of 200 μm, an apex angle of 120°, and a weight of 1.365 g, when the first glass plate 11 has a surface roughness Ra of 5.0 nm or less and a thickness of 2.5 mm. In the case where the critical collision fracture rate is 35 km/h or more, flying stone resistance can be improved. The critical collision fracture rate is more preferably 36 km/h or more, still more preferably 37 km/h or more, even more preferably 38 km/h or more, even still more preferably 39 km/h or more, particularly preferably 40 km/h or more, and most preferably 42 km/h or more. The upper limit of the critical collision fracture rate is, for example, 120 km/h or less.

In addition, the laminated glass according to the present embodiment preferably has a critical collision fracture rate of 35 km/h or more upon collision on the surface of the first glass plate 11 with a tungsten carbide superhard alloy having a tip curvature radius of 200 μm, an apex angle of 120°, and a weight of 1.365 g. In the case where the critical collision fracture rate is 35 km/h or more, flying stone resistance can be further improved. The critical collision fracture rate is more preferably 37 km/h or more, still more preferably 40 km/h or more, even more preferably 45 km/h or more, even still more preferably 50 km/h or more, particularly preferably 55 km/h or more, and most preferably 60 km/h or more. The upper limit of the critical collision fracture rate is, for example, 120 km/h or less.

The total thickness of the first glass plate 11, the second glass plate 12, and the interlayer 13 is preferably 4.5 mm or more. In particular, in the case where the laminated glass according to the present embodiment has the above properties, the total thickness of the first glass plate 11, the second glass plate 12, and the interlayer 13 is preferably 4.5 mm or more. In the case where the total thickness is 4.5 mm or more, sound insulation property can be improved. The total thickness is more preferably 4.6 mm or more, still more preferably 4.7 mm or more, even more preferably 4.8 mm or more, particularly preferably 4.9 mm or more, and most preferably 5.0 mm or more. In addition, the total thickness is preferably 8.0 mm or less, more preferably 7.8 mm or less, still more preferably 7.6 mm or less, particularly preferably 7.4 mm or less, particularly preferably 7.2 mm or less, and most preferably 7.0 mm or less, from the viewpoint of weight reduction.

Note that, in the case where the total thickness of the first glass plate 11, the second glass plate 12, and the interlayer 13 varies depending on a portion, the total thickness is preferably 4.5 mm or more at the thinnest portion.

In the laminated glass according to the present embodiment, the ratio (t₁/t₂) of the thickness t₁ of the first glass plate to the thickness t₂ of the second glass plate is preferably 1.5 or more. In the case where the ratio (t₁/t₂) is 1.5 or more, a higher critical collision fracture rate can be achieved. The ratio (t₁/t₂) is more preferably 2.0 or more, still more preferably 2.5 or more, even more preferably 3.0 or more, particularly preferably 3.5 or more, and most preferably 4.0 or more. In addition, the ratio (t₁/t₂) is preferably 6.0 or less, more preferably 5.5 or less, and still more preferably 5.0 or less, in order to bring the curvatures of the glasses after the bending forming close to each other when producing the laminated glass.

In the laminated glass 10 according to the present embodiment, the visible light transmittance Tv defined in ISO-9050:2003 using a D65 light source is preferably 70% or more. The Tv is more preferably 71% or more, and still more preferably 72% or more. In addition, the Tv is, for example, 90% or less.

In the laminated glass 10 according to the present embodiment, the total solar transmittance Tts is preferably 70% or less, as defined in ISO-13837:2008 convention A and measured at a wind speed of 4 m/s. In the case where the total solar transmittance Tts of the laminated glass 10 according to the present embodiment is 70% or less, a sufficient heat shielding property can be obtained. The Tts is more preferably 68% or less, and still more preferably 66% or less. In addition, the Tts is, for example, 55% or more.

A method for producing the laminated glass 10 according to the present embodiment may be the same as that for a known laminated glass in the related art. For example, through steps of laminating the first glass plate 11, the interlayer 13, and the second glass plate 12 in this order and performing heating and pressing, the laminated glass 10 having a configuration in which the first glass plate 11 and the second glass plate 12 are bonded to each other via the interlayer 13 can be obtained.

In the method for producing the laminated glass 10 according to the present embodiment, for example, after a step of heating and forming each of the first glass plate 11 and the second glass plate 12, a step of inserting the interlayer 13 between the first glass plate 11 and the second glass plate 12 and performing heating and pressing may be performed. Through such steps, the laminated glass 10 having the configuration in which the first glass plate 11 and the second glass plate 12 are bonded to each other via the interlayer 13 may be obtained.

[Application]

Since the glass according to the present embodiment has excellent fracture toughness and excellent bending formability, the glass can be suitably used as a glass to be provided in a vehicle or a sensor, and more specifically, the glass can be suitably used as a window glass in a vehicle or a cover glass of a sensor.

In particular, since the glass according to the present embodiment has excellent fracture toughness and excellent bending formability, the glass is suitable for a window glass in a vehicle, specifically, a member such as a windshield, a side glass, a rear glass, or a roof glass. In addition, from the same viewpoint, the glass can be suitably used particularly as a cover glass for a sensor such as a LiDAR, a camera, or a millimeter wave radar to be mounted on a vehicle or an unmanned or manned eVTOL (electric vertical take-off and landing aircraft) such as a drone.

Hereinafter, as a specific application, an example in which the glass according to the present embodiment is used as a vehicular window glass is described with reference to the drawings.

FIG. 4 is a conceptual view illustrating a state where the laminated glass 10 including the glass according to the present embodiment is mounted on an opening 110 formed at a front part of an automobile 100 and used as an automobile window glass. In the laminated glass 10 used as the automobile window glass, a housing (case) 120 in which an information device or the like is housed for ensuring traveling safety of the vehicle may be attached to a surface on an inner side of the vehicle.

The information device housed in the housing is a device that uses a camera, a radar, or the like to prevent rear-end collision or collision with a preceding vehicle, a pedestrian, an obstacle, or the like in front of the vehicle or to notify a driver of a danger. For example, the information device is an information receiving device and/or an information transmitting device, includes a millimeter wave radar, a stereo camera, an infrared laser, or the like, and transmits and/or receives a signal. The “signal” is an electromagnetic wave including a millimeter wave, visible light, infrared light, or the like.

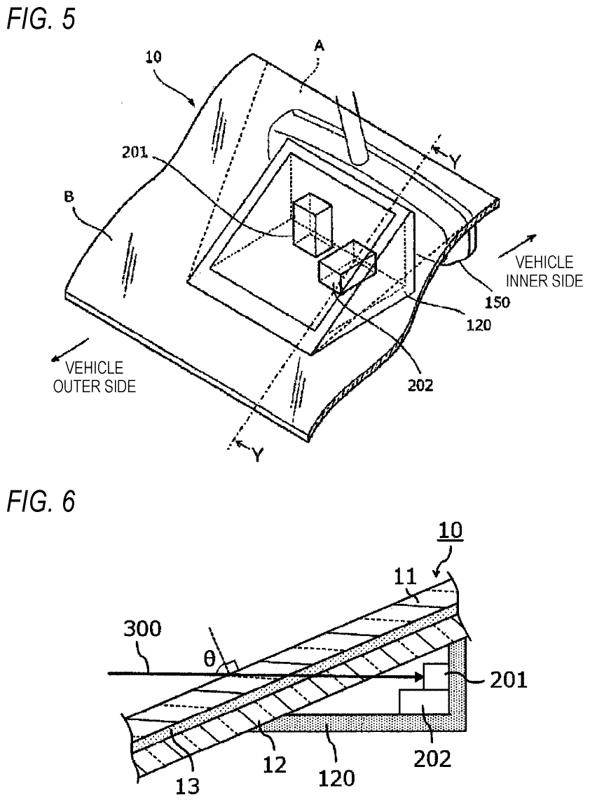

FIG. 5 is an enlarged view of the portion S in FIG. 4, and is a perspective view illustrating a portion where the housing 120 is attached to the laminated glass 10 according to the present embodiment. The housing 120 houses a millimeter wave radar 201 and a stereo camera 202 as the information device. The housing 120 in which the information device is housed is generally attached to a vehicle outer side with respect to a back mirror 150 and a vehicle inner side with respect to the laminated glass 10, or may be attached to another portion.

FIG. 6 is a cross-sectional view including the line Y-Y in FIG. 5 in a direction orthogonal to a horizontal line. The first glass plate 11 in the laminated glass 10 is preferably disposed on the vehicle outer side. With the above configuration, a windshield that is lightweight and has excellent fracture toughness can be implemented. In addition, since the glass according to the present embodiment has a low viscosity, it is easy to perform the bending forming when producing a windshield.

As described above, the following configurations are disclosed in the present description.
<1> A glass containing, in mol % in terms of oxides:
SiO₂: 60% to 72%;
Al₂O₃: 3.0% to 9.0%;
B₂O₃: 0.0% to 4.0%;
MgO: 3.0% to 15%;
CaO: 0.0% to 5.0%;
SrO: 0.0% to 5.0%;
BaO: 0.0% to 2.0%;
Li₂O: 1.0% to 10%;
Na₂O: 6.0% to 16%;
K₂O: 0.0% to 3.0%;
ZrO₂: 0.0% to 1.0%;
TiO₂: 0.0% to 1.0%;
Y₂O₃: 0.0% to 1.0%;
R₂O: 11% to 25%; and
RO: 7.0% to 20%,
(RO is at least one selected from MgO, CaO, SrO, and BaO, and R₂O is at least one selected from Li₂O, Na₂O, and K₂O).
<2> The glass according to <1>, which has a Young's modulus of 75 GPa or more.
<3> The glass according to <1> or <2>, which has a fracture toughness value K_{IC} of 0.76 MPa·m^{1/2} or more, as measured by an SEPB method.
<4> The glass according to any one of <1> to <3>, which has a yield point of 670° C. or lower.
<5> The glass according to any one of <1> to <4>, which has a ratio (H/L) of 0.10 or less where an H value to an L value are calculated according to the following equations,

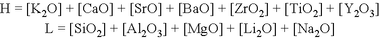

([ ] means a content of each component in the parentheses in mol % in terms of oxides). <6> The glass according to <5>, which has a fracture toughness value K_{IC} of 0.80 MPa·m^{1/2} or more, as measured by an SEPB method.
<7> The glass according to any one of <1> to <6>, which has a critical collision fracture rate of 35 km/h or more upon collision with a tungsten carbide superhard alloy having a tip curvature radius of 200 μm, an apex angle of 120°, and a weight of 1.365 g, when the glass has a surface roughness Ra of 5.0 nm or less and a thickness of 2.5 mm.
<8> The glass according to any one of <1> to <6>, which has a critical collision fracture rate of 53 km/h or more upon collision with a tungsten carbide superhard alloy having a tip curvature radius of 200 μm, an apex angle of 120°, and a weight of 1.365 g.
<9> The glass according to any one of <1> to <8>, which has a thickness of 2.5 mm or more.
<10> A vehicular window glass containing: the glass according to any one of <1> to <9>.
<11> A sensor-use glass containing: the glass according to any one of <1> to <9>.
<12> A laminated glass including:
a first glass plate;
a second glass plate; and
an interlayer sandwiched between the first glass plate and the second glass plate, in which
the first glass plate is the glass according to any one of <1> to <9>.
<13> The laminated glass according to <12>, which has a critical collision fracture rate of 35 km/h or more upon collision on a surface of the first glass plate with a tungsten carbide superhard alloy having a tip curvature radius of 200 μm, an apex angle of 120°, and a weight of 1.365 g, when the first glass plate has a surface roughness Ra of 5.0 nm or less and a thickness of 2.5 mm.
<14> The laminated glass according to <12> which has a critical collision fracture rate of 53 km/h or more upon collision on a surface of the first glass plate with a tungsten carbide superhard alloy having a tip curvature radius of 200 μm, an apex angle of 120°, and a weight of 1.365 g.
<15> The laminated glass according to any one of <12> to <14>, which has a total thickness of the first glass plate, the second glass plate, and the interlayer being 4.5 mm or more.
<16> The laminated glass according to any one of <12> to <15>, which has a ratio (t₁/t₂) of 1.5 or more where t₁ represents a thickness of the first glass plate and t₂ represents a thickness of the second glass plate.
<17> A laminated glass including:
a first glass plate;
a second glass plate; and
an interlayer sandwiched between the first glass plate and the second glass plate, in which
the first glass plate and the second glass plate are each the glass according to any one of <1> to <9>.
<18> The laminated glass according to any one of <12> to <16>, in which the second glass plate is a soda lime glass.
<19> The laminated glass according to any one of <12> to <16>, in which the second glass plate is an aluminosilicate glass.
<20> The laminated glass according to any one of <12> to <16>, in which the second glass plate has been subjected to a chemical strengthening treatment.

### EXAMPLES

Hereinafter, the present invention is specifically described with reference to Examples, but the present invention is not limited thereto.

### Preparation of Glass Plates in Example 1 to Example 18

Raw materials were charged into a platinum crucible so as to obtain each glass composition (unit:mol %) shown in Table 1, and melted at a temperature of 1600° C. to 1650° C. for 3 hours to obtain each molten glass. The molten glass was poured onto a carbon plate and annealed. Both surfaces of the obtained plate-shaped glass were polished to obtain a glass plate having a thickness of 2.00 mm. Example 1 to Example 11 are Inventive Examples, and Example 12 to Example 18 are Comparative Examples.

The glass plate obtained above was subjected to the following evaluations. The results are shown in Table 1 below. Note that, blank columns in the tables indicate not measured.

(1) Temperature T₂ and Temperature T₄:

The temperature T₂ at which the glass viscosity η was 10² dPa·s and the temperature T₄ at which the glass viscosity η was 10⁴ dPa·s, which served as references for meltability of the glass, were measured by using a rotational viscometer.

### (2) Glass Transition Temperature (T_{g}):

The glass transition temperature was a value measured by using a differential thermal dilatometer (TMA) and was determined based on the standard in JIS R3103-3 (2001).

### (3) Yield Point:

The yield point was a value measured by using a differential thermal dilatometer (TMA), and a temperature at which a thermal expansion curve was yielded at a temperature of T_{g} or higher was defined as the yield point.

### (4) Average Linear Expansion Coefficient at 50° C. to 350° C. (CTE₅₀₋₃₅₀):

The average thermal expansion coefficient was measured by using a differential thermal dilatometer (TMA) and was determined based on the standard in JIS R3102 (1995).

### (5) Density:

The density of about 20 g of a glass mass containing no bubble and cut out from the glass plate was measured with the Archimedes method.

### (6) Young's Modulus:

The Young's modulus was measured at 25° C. by using an ultrasonic pulse method (Olympus, DL35) based on JIS R1602:1995 “Testing methods for elastic modulus of fine ceramics”.

### (7) Rigidity Modulus:

The rigidity modulus was measured at 25° C. by using an ultrasonic pulse method (Olympus, DL35) based on JIS R1602:1995 “Testing methods for elastic modulus of fine ceramics”.

### (8) Poisson's Ratio:

The Poisson's ratio was measured at 25° C. by using an ultrasonic pulse method (Olympus, DL35) based on JIS R1602:1995 “Testing methods for elastic modulus of fine ceramics”.

### (9) Fracture Toughness Value in SEPB Method

The fracture toughness value of the glass plate obtained above was measured based on JIS R1607:2015 “Testing methods for fracture toughness of fine ceramics” using a pre-crack introduction fracture test method (SEPB method: single-edge-precracked-beam method).

### (10) Surface Fracture Energy

The Young's modulus and the fracture toughness value obtained above were used to calculate according to the above equation (1).

TABLE 1

| mol % | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| SiO₂ | 69.0 | 65.0 | 68.0 | 67.0 | 67.0 | 69.0 | 69.0 | 69.0 | 68.0 |
| Al₂O₃ | 3.0 | 9.0 | 5.0 | 6.0 | 5.0 | 5.0 | 5.0 | 4.0 | 4.0 |
| B₂O₃ | 0.0 | 0.0 | 0.0 | 0.0 | 0.0 | 0.0 | 0.0 | 0.0 | 0.0 |
| MgO | 4.0 | 8.0 | 10.0 | 11.0 | 12.0 | 12.0 | 12.0 | 12.0 | 12.0 |
| CaO | 4.0 | 0.0 | 0.0 | 1.0 | 2.0 | 1.0 | 2.0 | 3.0 | 3.0 |
| SrO | 4.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 |
| Li₂O | 1.0 | 8.0 | 8.0 | 7.0 | 6.0 | 5.0 | 2.0 | 2.0 | 3.0 |
| Na₂O | 11.0 | 10.0 | 9.0 | 8.0 | 8.0 | 8.0 | 10.0 | 10.0 | 10.0 |
| K₂O | 1.0 | 0.0 | 0.0 | 0.0 | 0.0 | 0.0 | 0.0 | 0.0 | 0.0 |
| ZrO₂ | 1.0 | 0.0 | 0.0 | 0.0 | 0.0 | 0.0 | 0.0 | 0.0 | 0.0 |
| TiO₂ | 1.0 | 0.0 | 0.0 | 0.0 | 0.0 | 0.0 | 0.0 | 0.0 | 0.0 |
| Y₂O₃ | 1.0 | 0.0 | 0.0 | 0.0 | 0.0 | 0.0 | 0.0 | 0.0 | 0.0 |
| R₂O | 13 | 18 | 17 | 15 | 14 | 13 | 12 | 12 | 13 |
| RO | 12 | 8 | 10 | 12 | 14 | 13 | 14 | 15 | 15 |
| H (=[ZrO₂] + [TiO₂] + | 12 | 0 | 0 | 1 | 2 | 1 | 2 | 3 | 3 |
| [Y₂O₃] + [CaO] + | | | | | | | | | |
| [SrO] + [BaO] + [K₂O]) | | | | | | | | | |
| L (=[SiO₂] + [Al₂O₃] + | 88 | 100 | 100 | 99 | 98 | 99 | 98 | 97 | 97 |
| [MgO] + [Li₂O] + | | | | | | | | | |
| [Na₂O]) | | | | | | | | | |
| H/L | 0.14 | 0.00 | 0.00 | 0.01 | 0.02 | 0.01 | 0.02 | 0.03 | 0.03 |
| MgO/RO | 0.33 | 1.00 | 1.00 | 0.92 | 0.86 | 0.92 | 0.86 | 0.80 | 0.80 |
| Li₂O/R₂O | 0.08 | 0.44 | 0.47 | 0.47 | 0.43 | 0.38 | 0.17 | 0.17 | 0.23 |
| (Li₂O—Na₂O)/R₂O | 0.92 | 1.00 | 1.00 | 1.00 | 1.00 | 1.00 | 1.00 | 1.00 | 1.00 |
| T₂ [° C.] | | 1511 | | | | 1533 | | | |
| T₄ [° C.] | | 1064 | | | | 1095 | | | |
| T_{g} [° C.] | 572 | 524 | 507 | 531 | 538 | 553 | 588 | 571 | 554 |
| Yield point [° C.] | 653 | 603 | 579 | 609 | 609 | 630 | 665 | 649 | 625 |
| CTE₅₀₋₃₅₀ [×10⁻⁷/° C.] | 86 | 89 | 87 | 82 | 79 | 75 | 77 | 79 | 83 |
| Density [g/cm³] | 2.66 | 2.46 | 2.45 | 2.46 | 2.48 | 2.45 | 2.46 | 2.47 | 2.48 |
| Young's modulus [GPa] | 80 | 83 | 82 | 83 | 84 | 82 | 79 | 80 | 81 |
| Rigidity modulus [GPa] | 33 | 34 | 33 | 34 | 34 | 34 | 33 | 33 | 33 |
| Specific elastic | 30 | 34 | 33 | 34 | 34 | 33 | 32.2 | 32.2 | 32.5 |
| modulus [MNm/kg] | | | | | | | | | |
| Poisson's ratio [—] | 0.23 | 0.22 | 0.22 | 0.22 | 0.22 | 0.22 | 0.22 | 0.22 | 0.22 |
| Fracture toughness | | 0.82 | | | | 0.85 | | | |
| value [MPa · m^{1/2}] | | | | | | | | | |
| in SEPB method | | | | | | | | | |
| Surface fracture | | 3.9 | | | | 4.2 | | | |
| energy [J/m²] | | | | | | | | | |
| | Ex. | Ex. | Ex. | Ex. | Ex. | Ex. | Ex. | Ex. | Ex. |
| mol % | 10 | 11 | 12 | 13 | 14 | 15 | 16 | 17 | 18 |
| SiO₂ | 68.0 | 68.0 | 69.6 | 55.0 | 60.0 | 58.9 | 65.1 | 65.3 | 66.0 |
| Al₂O₃ | 4.0 | 4.0 | 0.9 | 9.0 | 12.0 | 18.7 | 15.2 | 15.2 | 15.2 |
| B₂O₃ | 0.0 | 0.0 | 0.0 | 0.0 | 0.0 | 0.0 | 0.0 | 0.0 | 0.0 |
| MgO | 10.0 | 9.0 | 7.1 | 4.0 | 15.0 | 13.0 | 0.0 | 0.0 | 3.8 |
| CaO | 3.0 | 2.0 | 9.1 | 4.0 | 0.0 | 2.8 | 0.0 | 0.0 | 0.0 |
| SrO | 0.0 | 0.0 | 0.0 | 0.0 | 0.0 | 0.0 | 4.6 | 0.0 | 0.0 |
| BaO | 0.0 | 0.0 | 0.0 | 0.0 | 0.0 | 0.0 | 0.0 | 0.0 | 0.0 |
| Li₂O | 3.0 | 3.0 | 0.0 | 0.0 | 0.0 | 0.0 | 7.4 | 7.3 | 7.2 |
| Na₂O | 12.0 | 14.0 | 12.6 | 16.0 | 10.0 | 2.0 | 7.8 | 7.5 | 7.8 |
| K₂O | 0.0 | 0.0 | 0.6 | 6.0 | 2.0 | 4.6 | 0.0 | 0.0 | 0.0 |
| ZrO₂ | 0.0 | 0.0 | 0.0 | 0.0 | 1.0 | 0.0 | 0.0 | 0.0 | 0.0 |
| TiO₂ | 0.0 | 0.0 | 0.0 | 3.0 | 0.0 | 0.0 | 0.0 | 4.7 | 0.0 |
| Y₂O₃ | 0.0 | 0.0 | 0.0 | 3.0 | 0.0 | 0.0 | 0.0 | 0.0 | 0.0 |
| R₂O | 15 | 17 | 13 | 22 | 12 | 7 | 15 | 15 | 15 |
| RO | 13 | 11 | 16 | 8 | 15 | 16 | 5 | 0 | 4 |
| H (=[ZrO₂] + [TiO₂] + | 3 | 2 | 10 | 16 | 3 | 7 | 5 | 5 | 0 |
| [Y₂O₃] + [CaO] + | | | | | | | | | |
| [SrO] + [BaO] + [K₂O]) | | | | | | | | | |
| L (=[SiO₂] + [Al₂O₃] + | 97 | 98 | 90 | 84 | 97 | 93 | 95 | 95 | 100 |
| [MgO] + [Li₂O] + | | | | | | | | | |
| [Na₂O]) | | | | | | | | | |
| H/L | 0.03 | 0.02 | 0.11 | 0.19 | 0.03 | 0.08 | 0.05 | 0.05 | 0.00 |
| MgO/RO | 0.77 | 0.82 | 0.44 | 0.50 | 1.00 | 0.82 | 0.00 | — | 1.00 |
| Li₂O/R₂O | 0.20 | 0.18 | 0.00 | 0.00 | 0.00 | 0.00 | 0.48 | 0.49 | 0.48 |
| (Li₂O—Na₂O)/R₂O | 1.00 | 1.00 | 0.95 | 0.73 | 0.83 | 0.30 | 1.00 | 1.00 | 1.00 |
| T₂ [° C.] | 1486 | 1471 | 1421 | | | | | | |
| T₄ [° C.] | 1058 | 1039 | 1025 | | | | | | |
| T_{g} [° C.] | 530 | 512 | 549 | 600 | 700 | 702 | 603 | 654 | 632 |
| Yield point [° C.] | 600 | 586 | 620 | 674 | | | 685 | 732 | 725 |
| CTE₅₀₋₃₅₀ [×10⁻⁷/° C.] | 86 | 95 | 91 | 115 | | 56 | | | |
| Density [g/cm³] | 2.48 | 2.47 | 2.51 | 2.70 | 2.53 | 2.54 | 2.55 | 2.45 | 2.43 |
| Young's modulus [GPa] | 79 | 77 | 74 | 80 | 81 | | 80 | 79 | 82 |
| Rigidity modulus [GPa] | 32 | 31 | 30 | 32 | | | | | |
| Specific elastic | 31.8 | 31.1 | 30 | 30 | | | | | |
| modulus [MNm/kg] | | | | | | | | | |
| Poisson's ratio [—] | 0.22 | 0.22 | 0.23 | 0.24 | | | 0.23 | 0.22 | 0.22 |
| Fracture toughness | 0.78 | 0.77 | 0.75 | | | | | | |
| value [MPa · m^{1/2}] | | | | | | | | | |
| in SEPB method | | | | | | | | | |
| Surface fracture | 3.7 | 3.7 | 3.6 | | | | | | |
| energy [J/m²] | | | | | | | | | |

It is found that the glasses in Examples 1 to 11 have a high Young's modulus of 75 GPa or more and excellent fracture toughness. In addition, since the yield point is 670° C. or lower, the glasses had a low viscosity and excellent bending formability.

On the other hand, in Example 12 as a Comparative Example, since Al₂O₃ was less than 3.0%, CaO was more than 5.0%, and Li₂O was less than 1.0%, the Young's modulus and the fracture toughness value were lower than those in Inventive Examples. In addition, in Example 13 as a Comparative Example, since SiO₂ is less than 60%, Li₂O is less than 1.0%, K₂O is more than 3.0%, TiO₂ is more than 1.0%, and Y₂O₃ is more than 1.0%, the yield point was high. In addition, in Example 14 as a Comparative Example, since Al₂O₃ was more than 9.0% and Li₂O was less than 1.0%, the T_{g} was high. Since the yield point is higher than the T_{g}, it is found that Example 14 has a higher yield point than 700° C. and poor bending formability. In addition, in Example 15 as a Comparative Example, since SiO₂ is less than 60%, Al₂O₃ is more than 9.0%, Li₂O is less than 1.0%, Na₂O is less than 6.0%, K₂O is more than 3.0%, and R₂O is less than 11%, the T_{g} was high. Since the yield point is higher than the T_{g}, it is found that Example 15 has a higher yield point than 702° C. and poor bending formability. In addition, in Examples 16 and 18 as Comparative Examples, since Al₂O₃ is more than 9.0% and RO is less than 7.0%, the yield point was high. In addition, in Example 17 as a Comparative Example, since Al₂O₃ is more than 9.0%, RO is less than 7.0%, and TiO₂ is more than 1.0%, the yield point was high.

### <Preparation of Laminated Glass>

Laminated glasses in Test Example 1 to Test Example 7 were produced by the following procedure. Test Examples 1 to 3 are Comparative Examples, and Test Examples 4 to 7 are Inventive Examples.

### Test Example 1

As the first glass plate and the second glass plate, a glass having a thickness of 2.0 mm and a surface roughness Ra of 2.0 nm or less and having a composition shown in Example 13 in Table 1 was used. As the interlayer, a polyvinyl butyral (PVB) having a thickness of 0.78 mm was used. The first glass plate, the interlayer, and the second glass plate were laminated in this order, pre-bonded at 120° C. for 15 minutes, and then pressure-bonded under conditions of 130° C. and 1 MPa. Thereafter, the temperature was returned to room temperature and the pressure was returned to atmospheric pressure over 90 minutes to prepare a laminated glass in Test Example 1. In the laminated glass in Test Example 1, the total thickness of the first glass plate, the second glass plate, and the interlayer was 4.8 mm, and the ratio (t₁/t₂) of the thickness t₁ of the first glass plate to the thickness t₂ of the second glass plate was 1.0.

### Test Example 2

A laminated glass was prepared in the same manner as in Test Example 1 except that the thicknesses of the first glass plate and the second glass plate were changed to the values shown in Table 2.

### Test Example 3

A laminated glass was prepared in the same manner as in Test Example 1 except that the thickness of the first glass plate was changed to the value shown in Table 2, and a soda lime glass (model number: AS2, manufactured by AGC Inc.) having a thickness of 0.7 mm was used as the second glass plate.

### Test Examples 4 to 7

A laminated glass was prepared in the same manner as in Test Example 3 except that the type of the first glass plate was changed to that shown in Table 2 (each having a surface roughness Ra of 2.0 nm or less).

A critical collision fracture rate Vcrt of the laminated glass obtained above was measured by the following procedure.

### <Procedure>

A tungsten carbide superhard alloy having a tip curvature radius of 200 μm, an apex angle of 120°, and a weight of 1.365 g was injected at a rate of 20 km/h or more and caused to collide with the surface of the first glass plate. A growth process of a crack generated by the collision with the tungsten carbide superhard alloy was observed from a cross section of the laminated glass during this collision by using a high-speed camera. The test was performed while changing the injection rate, and in the case where the crack generated on the surface of the first glass plate progressed and reached the surface of the first glass plate opposite to the surface with which the tungsten carbide superhard alloy was collided, the crack was determined as cracking, and the collision rate at this time was defined as the critical collision fracture rate Vcrt.

TABLE 2

| | | Test | Test | Test | Test | Test | Test | Test |
|---|---|---|---|---|---|---|---|---|
| | | Ex. 1 | Ex. 2 | Ex. 3 | Ex. 4 | Ex. 5 | Ex. 6 | Ex. 7 |
| First | Glass type | Ex. 12 | Ex. 12 | Ex. 12 | Ex. 2 | Ex. 6 | Ex. 10 | Ex. 11 |
| glass plate | Thickness [mm] | 2.0 | 3.0 | 3.3 | 3.3 | 3.3 | 3.3 | 3.3 |
| Interlayer | Interlayer type | PVB | PVB | PVB | PVB | PVB | PVB | PVB |
| | Thickness [mm] | 0.78 | 0.78 | 0.78 | 0.78 | 0.78 | 0.78 | 0.78 |
| Second | Glass type | Ex. 12 | Ex. 12 | Soda | Soda | Soda | Soda | Soda |
| glass plate | | | | lime | lime | lime | lime | lime |
| | Thickness [mm] | 2.0 | 1.0 | 0.7 | 0.7 | 0.7 | 0.7 | 0.7 |

| | | | | | | | |
|---|---|---|---|---|---|---|---|
| Total thickness [mm] of | 4.8 | 4.8 | 4.8 | 4.8 | 4.8 | 4.8 | 4.8 |
| laminated glass | | | | | | | |
| Ratio (t₁/t₂) of thickness | 1.0 | 3.0 | 4.7 | 4.7 | 4.7 | 4.7 | 4.7 |
| t₁ of first glass plate to | | | | | | | |
| thickness t₂ of second | | | | | | | |
| glass plate | | | | | | | |
| Critical collision | 28 | 44 | 52 | 60 | 62 | 54 | 53 |
| fracture rate V_{crt} [km/h] | | | | | | | |

The laminated glasses in Test Examples 4 to 7, as Inventive Examples, have a critical collision fracture rate higher than that in Comparative Examples.

Note that, the present application is based on a Japanese Patent Application No. 2023-075162 filed on Apr. 28, 2023, contents of which are incorporated herein by reference.

### REFERENCE SIGNS LIST

10 laminated glass
11 first glass plate
12 second glass plate
13 interlayer
100 automobile
110 opening
120 housing
150 back mirror
201 millimeter wave radar
202 stereo camera
300 radio wave

What is claimed is:

1. A glass comprising, in mol % in terms of oxides:
SiO₂: 60% to 72%;
Al₂O₃: 3.0% to 9.0%;
B₂O₃: 0.0% to 4.0%;
MgO: 3.0% to 15%;
CaO: 0.0% to 5.0%;
SrO: 0.0% to 5.0%;
BaO: 0.0% to 2.0%;
Li₂O: 1.0% to 10%;
Na₂O: 6.0% to 16%;
K₂O: 0.0% to 3.0%;
ZrO₂: 0.0% to 1.0%;
TiO₂: 0.0% to 1.0%;
Y₂O₃: 0.0% to 1.0%;
R₂O: 11% to 25%; and
RO: 7.0% to 20%,
(RO is a total content of MgO, CaO, SrO, and BaO, and R₂O is a total content of Li₂O, Na₂O, and K₂O).

2. The glass according to claim 1, which has a Young's modulus of 75 GPa or more.

3. The glass according to claim 2, which has a fracture toughness value K_{IC} of 0.76 MPa·m^{1/2} or more, as measured by an SEPB method.

4. The glass according to claim 1, which has a yield point of 670° C. or lower.

5. The glass according to claim 4, which has a ratio (H/L) of 0.10 or less where an H value to an L value are calculated according to the following equations, 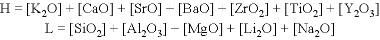
([ ] means a content of each component in the parentheses in mol % in terms of oxides).

6. The glass according to claim 5, which has a fracture toughness value K_{IC} of 0.80 MPa·m^{1/2} or more, as measured by an SEPB method.

7. The glass according to claim 1, which has a critical collision fracture rate of 35 km/h or more upon collision with a tungsten carbide superhard alloy having a tip curvature radius of 200 μm, an apex angle of 120°, and a weight of 1.365 g, when the glass has a surface roughness Ra of 5.0 nm or less and a thickness of 2.5 mm.

8. The glass according to claim 1, which has a critical collision fracture rate of 53 km/h or more upon collision with a tungsten carbide superhard alloy having a tip curvature radius of 200 μm, an apex angle of 120°, and a weight of 1.365 g.

9. The glass according to claim 8, which has a thickness of 2.5 mm or more.

10. A vehicular window glass comprising:
the glass according to claim 1.

11. A sensor-use glass, comprising:
the glass according to claim 1.

12. A laminated glass comprising:
a first glass plate;
a second glass plate; and
an interlayer sandwiched between the first glass plate and the second glass plate, wherein
the first glass plate is the glass according to claim 1.

13. The laminated glass according to claim 12, which has a critical collision fracture rate of 35 km/h or more upon collision on a surface of the first glass plate with a tungsten carbide superhard alloy having a tip curvature radius of 200 μm, an apex angle of 120°, and a weight of 1.365 g, when the first glass plate has a surface roughness Ra of 5.0 nm or less and a thickness of 2.5 mm.

14. The laminated glass according to claim 12, which has a critical collision fracture rate of 53 km/h or more upon collision on a surface of the first glass plate with a tungsten carbide superhard alloy having a tip curvature radius of 200 μm, an apex angle of 120°, and a weight of 1.365 g.

15. The laminated glass according to claim 14, which has a total thickness of the first glass plate, the second glass plate, and the interlayer being 4.5 mm or more.

16. The laminated glass according to claim 12, which has a ratio (t₁/t₂) of 1.5 or more where t₁ represents a thickness of the first glass plate and t₂ represents a thickness of the second glass plate.

17. A laminated glass comprising:
a first glass plate;
a second glass plate; and
an interlayer sandwiched between the first glass plate and the second glass plate, wherein
the first glass plate and the second glass plate are each the glass according to claim 1.

18. The laminated glass according to claim 12, wherein the second glass plate is a soda lime glass.

19. The laminated glass according to claim 12, wherein the second glass plate is an aluminosilicate glass.

20. The laminated glass according to claim 12, wherein the second glass plate has been subjected to a chemical strengthening treatment.
